(19) United States
(12) Patent Application Publication
(10) Pub. No.: US 2025/0016661 A1
(43) Pub. Date: Jan. 9, 2025

(54) METHOD AND APPARATUS FOR DETERMINING SYNCHRONIZATION SIGNAL BLOCK LOCATIONS FOR SMALL BANDWIDTH CHANNELS

(71) Applicant: Huawei Technologies Co., Ltd., Shenzhen (CN)

(72) Inventors: Vipul Desai, Palatine, IL (US); Brian Classon, St. Pete Beach, FL (US)

(21) Appl. No.: 18/897,568

(22) Filed: Sep. 26, 2024

Related U.S. Application Data
(63) Continuation of application No. PCT/US2023/016621, filed on Mar. 28, 2023.
(60) Provisional application No. 63/324,988, filed on Mar. 29, 2022.
(60) Provisional application No. 63/422,679, filed on Nov. 4, 2022.

(51) Int. Cl. H04W 48/10; H04L 5/00; H04W 56/00; H04W 72/044

(52) U.S. Cl. CPC H04W 48/10; H04L 5/0048; H04W 56/0015; H04W 72/044

(57) ABSTRACT

A base station generates a punctured synchronization signal block (SSB) for a channel of a frequency band based on a SSB. A bandwidth of the SSB exceeds a bandwidth of the channel. The punctured SSB includes a punctured physical broadcast channel (PBCH), a primary synchronization signal (PSS), and a secondary synchronization signal (SSS). The PSS of the punctured SSB has a center frequency indicated by a sync raster location of a set of sync raster locations associated with the frequency band. The punctured PBCH is obtained from a PBCH of the first SSB based on a puncture pattern associated with the sync raster location. The base station transmits the punctured SSB in the channel. A user equipment (UE) detects the punctured SSB according to the sync raster location.

### CROSS-REFERENCE TO RELATED APPLICATIONS

This patent application is a continuation of International Application No. PCT/US2023/016621, filed on Mar. 28, 2023, and entitled “Method and Apparatus for Determining Synchronization Signal Block Locations for Small Bandwidth Channels,” which claims priority to U.S. Provisional Application No. 63/324,988, filed on Mar. 29, 2022, and entitled “Determining Synchronization Burst Locations for Small Bandwidth Channels,” and to U.S. Provisional Application No. 63/422,679, filed on Nov. 4, 2022 and entitled “Determining Synchronization Burst Locations for Small Bandwidth Channels.” All of the aforementioned patent applications are hereby incorporated by reference herein as if reproduced in their entireties.

### TECHNICAL FIELD

The present disclosure relates generally to wireless communications, and, in particular embodiments, to methods and apparatus for determining synchronization block locations for small bandwidth channels.

### BACKGROUND

A communication network may include a base station having a coverage area and a plurality of user equipments (UEs). The base station may establish uplink and downlink connections with the UEs, which serve to carry data from the UEs to the base station and from the base station to the UEs. The base station may periodically transmit synchronization signal blocks (SSBs). When a UE searches for the base station or a cell, e.g., when the UE is powered on or in the idle state, or when the UEs enters the coverage area of the base station/cell, the UE may use the SSBs to derive information required to synchronize with the base station/cell and access the base station/cell. It is expected that UEs are able to determine where to detect the SSBs in order to access the base station/cell.

### SUMMARY

Technical advantages are generally achieved, by embodiments of this disclosure which describe methods and apparatus for determining synchronization signal block locations for small bandwidth channels.

According to one aspect of the present disclosure, a method is provided that includes: receiving, by a user equipment (UE) from a base station, a punctured synchronization signal block (SSB) in a channel of a frequency band, wherein the punctured SSB comprises a primary synchronization signal (PSS), a secondary synchronization signal (SSS), and a punctured physical broadcast channel (PBCH) obtained from a first PBCH of a first SSB by applying a first puncture pattern to reduce a first number of resource blocks (RBs) of the first PBCH to a second number of RBs for transmission, the PSS of the punctured SSB has a center frequency indicated by a first sync raster location of a first set of sync raster locations associated with the frequency band, and the first puncture pattern is associated with the first sync raster location; and detecting, by the UE, the punctured SSB according to the first sync raster location.

Optionally, in any of the preceding aspects, the punctured SSB has a bandwidth not larger than a bandwidth of the channel, and the first SSB has a bandwidth exceeding the bandwidth of the channel.

Optionally, in any of the preceding aspects, a difference between the bandwidth of the first SSB and the bandwidth of the punctured SSB is related to the second number of RBs transmitted.

Optionally, in any of the preceding aspects, the method further includes: determining, by the UE, attributes of the channel based on the received punctured PBCH in the punctured SSB, the attributes comprising a starting frequency location of the channel.

Optionally, in any of the preceding aspects, determining the attributes of the channel comprises: determining, by the UE, the starting frequency location of the channel based on the received punctured PBCH, the center frequency of the PSS of the punctured SSB and the first puncture pattern.

Optionally, in any of the preceding aspects, determining the attributes of the channel comprises: determining, by the UE, the starting frequency location of the channel based on the received punctured PBCH, a frequency location of a RB occupied by the PSS of the punctured SSB, and an offset with respect to the frequency location of the RB.

Optionally, in any of the preceding aspects, the PSS of the first SSB has a center frequency indicated by a second sync raster location of a second set of sync raster locations.

Optionally, in any of the preceding aspects, frequencies of the first set of sync raster locations are based on a first raster spacing and a first set of shift spacings, and frequencies of the second set of sync raster locations are based on a second raster spacing and a second set of shift spacings.

Optionally, in any of the preceding aspects, the first raster spacing is different from the second raster spacing, and the first raster spacing is related to a channel raster location of the channel.

Optionally, in any of the preceding aspects, the second raster spacing is a multiple of the first raster spacing.

Optionally, in any of the preceding aspects, one or more shift spacings of the first set of shift spacings are different from one or more shift spacings of the second set of shift spacings.

Optionally, in any of the preceding aspects, the first set of sync raster locations is obtained by shifting the second set of sync raster locations in a frequency domain.

Optionally, in any of the preceding aspects, a bandwidth of the channel is less than or equal to 5 MHz.

Optionally, in any of the preceding aspects, a frequency span of the first SSB is 20 RBs.

Optionally, in any of the preceding aspects, the first set of sync raster locations comprises a third sync raster location associated with a second puncture pattern.

According to another aspect of the present disclosure, a method is provided that includes: generating, by a base station, a punctured synchronization signal block (SSB) for a channel of a frequency band based on a first SSB having a first bandwidth exceeding a second bandwidth of the channel, wherein the first SSB comprises a first physical broadcast channel (PBCH), a primary synchronization signal (PSS), and a secondary synchronization signal (SSS), the punctured SSB comprises the PSS and the SSS, and a punctured PBCH obtained from the first PBCH by applying a first puncture pattern to reduce a first number of resource blocks (RBs) of the first PBCH to a second number of RBs for transmission, the PSS of the punctured SSB has a center frequency indicated by a first sync raster location of a first set of sync raster locations associated with the frequency band, and the first puncture pattern is associated with the first sync raster location; and transmitting, by the base station, the punctured SSB in the channel.

Optionally, in any of the preceding aspects, the punctured SSB has a third bandwidth not larger than the second bandwidth of the channel.

Optionally, in any of the preceding aspects, a difference between the first bandwidth of the first SSB and the third bandwidth of the punctured SSB is related to the second number of RBs transmitted.

Optionally, in any of the preceding aspects, the punctured PBCH comprises information indicating attributes of the channel, the attributes comprising a starting frequency location of the channel.

Optionally, in any of the preceding aspects, the starting frequency location of the channel is determinable based on the punctured PBCH, the center frequency of the PSS of the punctured SSB and the first puncture pattern.

Optionally, in any of the preceding aspects, the starting frequency location of the channel is determinable based on the punctured PBCH, a frequency location of a RB occupied by the PSS of the punctured SSB, and an offset with respect to the frequency location of the RB.

Optionally, in any of the preceding aspects, the PSS of the first SSB has a center frequency indicated by a second sync raster location of a second set of sync raster locations.

Optionally, in any of the preceding aspects, frequencies of the first set of sync raster locations are based on a first raster spacing and a first set of shift spacings, and frequencies of the second set of sync raster locations are based on a second raster spacing and a second set of shift spacings.

Optionally, in any of the preceding aspects, the first raster spacing is different from the second raster spacing, and the first raster spacing is related to a channel raster location of the channel.

Optionally, in any of the preceding aspects, the second raster spacing is a multiple of the first raster spacing.

Optionally, in any of the preceding aspects, one or more shift spacings of the first set of shift spacings are different from one or more shift spacings of the second set of shift spacings.

Optionally, in any of the preceding aspects, the first set of sync raster locations is obtained by shifting the second set of sync raster locations in a frequency domain.

Optionally, in any of the preceding aspects, the second bandwidth of the channel is less than or equal to 5 MHz.

Optionally, in any of the preceding aspects, a frequency span of the first SSB is 20 RBs.

Optionally, in any of the preceding aspects, the first set of sync raster locations comprises a third sync raster location associated with a second puncture pattern.

According to another aspect of the present disclosure, an apparatus is provided that includes: a non-transitory memory storage comprising instructions; and one or more processors in communication with the memory storage, wherein the instructions, when executed by the one or more processors, cause the apparatus to perform a method in any of the preceding aspects.

According to another aspect of the present disclosure, a non-transitory computer-readable media is provided. The non-transitory computer-readable media stores computer instructions, that when executed by one or more processors, cause the one or more processors to perform a method in any of the preceding aspects.

According to another aspect of the present disclosure, a system is provided that includes a base station (BS), and a user equipment (UE) in communication with the base station. The BS is configured to perform: generating a punctured synchronization signal block (SSB) for a channel of a frequency band based on a first SSB having a first bandwidth exceeding a second bandwidth of the channel, wherein the first SSB comprises a first physical broadcast channel (PBCH), a primary synchronization signal (PSS), and a secondary synchronization signal (SSS), the punctured SSB comprises the PSS and the SSS, and a punctured PBCH of the first PBCH obtained from the first PBCH by applying a first puncture pattern to reduce a first number of resource blocks (RBs) of the first PBCH to a second number of RBs for transmission, the PSS of the punctured SSB has a center frequency indicated by a first sync raster location of a first set of sync raster locations associated with the frequency band, and the first puncture pattern is associated with the first sync raster location; and transmitting the punctured SSB in the channel. The UE is configured to perform: receiving the punctured SSB in the channel, and detecting the punctured SSB according to the first sync raster location.

According to another aspect of the present disclosure, an apparatus is provided that includes a receiver module configured to receive, from a base station, a punctured synchronization signal block (SSB) of a first SSB for a channel of a frequency band, wherein the first SSB comprises a first physical broadcast channel (PBCH), a primary synchronization signal (PSS), and a secondary synchronization signal (SSS), the punctured SSB comprises the PSS and the SSS, and a punctured PBCH obtained from the first PBCH by applying a first puncture pattern to reduce a first number of resource blocks (RBs) of the first PBCH to a second number of RBs for transmission, the PSS of the punctured SSB has a center frequency indicated by a first sync raster location of a first set of sync raster locations configured for the frequency band, and the first puncture pattern is associated with the first sync raster location. The apparatus further includes a detecting module configured to detect the punctured SSB according to the first sync raster location.

According to another aspect of the present disclosure, an apparatus is provided that includes a generating module configured to generate a punctured synchronization signal block (SSB) for a channel of a frequency band based on a first SSB having a first bandwidth exceeding a second bandwidth of the channel, wherein the first SSB comprises a first physical broadcast channel (PBCH), a primary synchronization signal (PSS), and a secondary synchronization signal (SSS), the punctured SSB comprises a punctured PBCH of the first PBCH, the PSS and the SSS, the punctured PBCH being obtained from the first PBCH by applying a first puncture pattern to reduce a first number of resource blocks (RBs) of the first PBCH to a second number of RBs for transmission, the PSS of the punctured SSB has a center frequency indicated by a first sync raster location of a first set of sync raster locations associated with the frequency band, and the first puncture pattern is associated with the first sync raster location. The apparatus further includes a transmitter module configured to transmit the punctured SSB in the channel.

Aspects of the present disclosure enable communication of synchronization signal blocks in a channel having a small bandwidth, e.g., a bandwidth less than or equal to 5 MHz, and enable supporting wireless communications of devices operating in small bandwidths.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a diagram of an example communications system;

FIG. 2 is a diagram of an example resource grid;

FIG. 3 is a diagram of example relationships between GSCN and ARFCN;

FIG. 4 is a diagram showing example locations of SSBs in a channel;

FIG. 5 is a diagram showing example notations used in analysis of synchronization raster locations in a channel according to embodiments of the present disclosure;

FIG. 6 is a diagram showing example notations used in another analysis of synchronization raster locations with offsets according to embodiments of the present disclosure;

FIG. 7 is a diagram showing example notations used in yet another analysis of synchronization raster locations with offsets according to embodiments of the present disclosure;

FIG. 8 is a diagram showing example truncation of a SSB according to embodiments of the present disclosure;

FIG. 9 is a diagram showing another example truncation of a SSB according to embodiments of the present disclosure;

FIG. 10A and FIG. 10B are diagrams showing further examples of truncation of a SSB according to embodiments of the present disclosure;

FIG. 11 is a diagram of an embodiment truncated SSB;

FIG. 12 is a diagram showing example notations used in truncation of an SSB;

FIG. 13 is a flowchart of embodiment operations for detecting a SSB in a channel;

FIG. 14 is a diagram of example alternate channels for transmitting a SSB according to embodiments of the present disclosure;

FIG. 15 is a diagram of example alternate raster locations for a SSB in a channel according to embodiments of the present disclosure;

FIG. 16 is a flowchart of example operations for detecting a SSB by a UE according to embodiments of the present disclosure;

FIG. 17 is another flowchart of example operations for detecting a SSB by a UE according to embodiments of the present disclosure;

FIG. 18 is a diagram showing example locations of a SSB and CORESET #0 in a time-frequency grid according to embodiments of the present disclosure;

FIG. 19 is a diagram of example operations by a UE for locating a SSB according to embodiments of the present disclosure;

FIG. 20 is a flowchart of an embodiment method for SSB communication;

FIG. 21 is a flowchart of another embodiment method for SSB communication;

FIG. 22 is a diagram of an embodiment communication system;

FIG. 23A is a diagram of an embodiment end device (ED);

FIG. 23B is a diagram of an embodiment base station; and

FIG. 24 is a block diagram of an embodiment computing system.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF THE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

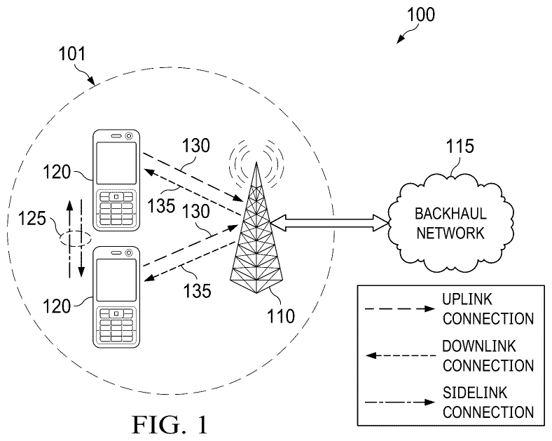

FIG. 1 is a diagram of an example communications system 100. Communications system 100 includes an access node (AN) 110 within a coverage area 101 that serve user equipments (UEs), such as UEs 120. In a first operating mode, communications to and from a UE 120 passes through the access node 11o with the coverage area 101. The access node 110 is connected to a backhaul network 115 for connecting to the internet, operations and management, and so forth. In a second operating mode, communications to and from a UE 120 do not pass through the access node 110, however, the access node 11o typically allocates resources used by the UE 120 to communicate when specific conditions are met. Communications between a pair of UEs 120 can use a sidelink connection (shown as two separate one-way connections 125). In FIG. 1, the sideline communication is occurring between two UEs 120 operating inside of the coverage area 101. However, sidelink communications, in general, can occur when the two UEs 120 are both outside the coverage area 101, both inside the coverage area 101, or one UE is inside and the other UE is outside the coverage area 101. Communication between a UE and access node pair occur over uni-directional communication links, where communication links from the UE to the access node are referred to as uplinks 130, and communication links from the access node to UE is referred to as downlinks 135.

Access nodes may also be commonly referred to as access points, Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on. UEs may also be commonly referred to as mobile stations, mobiles, terminals, terminal devices, users, subscribers, stations, and the like. Access nodes may provide wireless access in accordance with one or more wireless communication protocols, e.g., the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, etc. While it is understood that communications systems may employ multiple access nodes capable of communicating with a number of UEs, only one access node and two UEs are illustrated in FIG. 1 for simplicity.

Signals are communicated in time and frequency resources. A time and frequency resource may be allocated in a unit of a physical resource block (PRB). For NR mobile broadband (MBB) communication, in a slot, each PRB in the resource grid is defined as a span of 14 consecutive orthogonal frequency division multiplexed (OFDM) symbols in the time domain and 12 consecutive subcarriers in the frequency domain, i.e., each PRB contains 12×14 resource elements (REs). Each RE is located on one OFDM symbol in the time domain and one subcarrier in the frequency domain. When used as a frequency-domain unit, a PRB is 12 consecutive subcarriers. There are 14 symbols in a slot when a normal cyclic prefix is used and 12 symbols in a slot when an extended cyclic prefix is used. The duration of a symbol is inversely proportional to the subcarrier spacing (SCS). For a {15, 30, 60, 120} kHz SCS, the duration of a slot is {1, 0.5, 0.25, 0.125} ms, respectively. Each PRB maybe allocated to a control channel, a shared channel, a feedback channel, reference signals, and/or any combination thereof. In addition, some REs of a PRB may be reserved. A similar structure may be used on the sidelink (SL) as well. A communication resource maybe a PRB, a set of PRBs, a code (if code division multiple access (CDMA) is used, similarly as for the physical uplink control channel (PUCCH)), a physical sequence, a set of REs, and so on.

When a user equipment (UE), e.g., in the RRC_IDLE (idle) state, attempts to find a base station, the UE first searches for synchronization signal blocks (SSBs) transmitted by the base station. The SSB may include a primary synchronization signal (PSS), a secondary synchronization signal (SSS), and physical broadcast channel (PBCH) (which may contain the master information block (MIB)). From the MIB, the initial downlink bandwidth part (DL BWP) maybe established, and parameters to establish CORESET #0 may also be obtained, which is used to configure the resources used for physical downlink control channel (PDCCH) (which carries downlink control information (DCI)). The DCI may schedule resources for a physical downlink shared channel (PDSCH). The PDSCH may carry the system information block (SIB). The SSB enables the UE to synchronize with the base station and establish connection with the base station for communications.

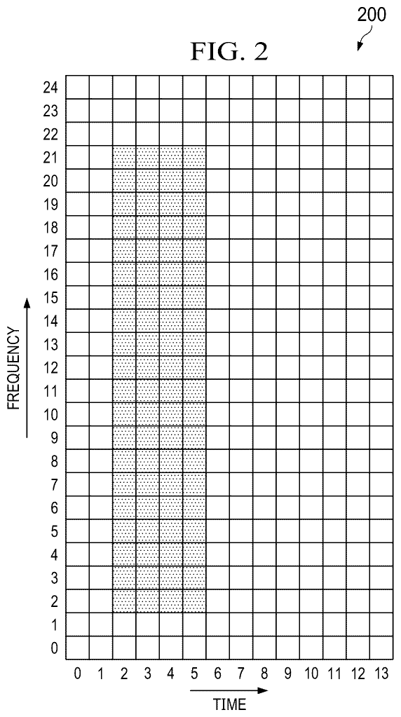

FIG. 2 is a diagram of an example resource grid 200 including 25 RBs in the frequency domain (numbered from 0 to 24) and 14 symbols in the time domain (numbered from 0 to 13). FIG. 2 shows that the SSB may occupy 20 RBs (dotted boxes) in frequency (e.g., from RB 2 to RB 21) and span 4 symbols (e.g., symbols 2-5). The center of the SSB (e.g., located on RE #0 of the RB #12), is not necessarily aligned to RE #0 of a RB.

In the frequency domain, a SSB is generally centered on one of a predefined set of frequency locations. This set of frequency locations (or frequencies) is also called a synchronization (sync) raster, and provides a list of center frequencies of possible SSBs. Each entry of the sync raster represents a frequency (location) where a SSB maybe centered. In the following description, the terms of “sync raster,” “sync raster location,” “raster location” and “raster point” are used interchangeably. An example set of sync raster locations is provided in Table 1 below. Table 1 shows a partial set from Table 5.4.3.3-1 in 3GPP TS 38.104, “NR; Base Station (BS) radio transmission and reception,” which is herein incorporated by reference in its entirety, and band n1 is defined in Table 5.2-1 of 3GPP TS 38.104. As an example, if a UE is capable of operating in band n1, Table 1 indicates that the SCS for a SSB transmitted in that band n1 is 15 kHz. The time locations of the SSB are indicated by “Case A,” which corresponds to timings in clause 4 of TS 38.213, “NR; Physical layer procedures for control,” which is herein incorporated by reference in its entirety. The possible frequency locations of the SSB for that band are given by a global synchronization channel number (GSCN). The GSCN can be mapped into frequency using the relationship provided in Table 2 below, or converted to a new radio (NR) absolute radio frequency channel number (ARFCN) using the relationship provided in Table 3 below. As shown in Table 1, the first GSCN in the band is 5279, the next location can be determined by adding the offset <1> to the previous location, and the last location is 5419. Note that the offset can be an integer greater than 0.

For a band, the possible frequency locations given by the GSCN depend on guard bands of the SSB, the minimum channel bandwidth for a channel in that band, and the SCS. Note that a band can support one or more channels. As an example, band n1 spans 60 MHz in the downlink (2110-2170 MHz). There can be many combinations of channels deployed by a network operator in band n1, such as 5, 10, 15, 20, 25, 30, 40, 50, and 60 MHz channels. If an operator is licensed to use 30 MHz in band n1, it can deploy combinations of channels such as (5, 5, 5, 15) MHz, (30) MHz, (25, 5) MHz, and so on. In general, the sync raster for any band is independent of the channelization within a band (outside the consideration for the guard bands of the band). Generally, the standards may define the range of GSCNs for each band. One or more channels may be defined in a band. For a specific channel in a band, a subset of this range of GSCNs needs to be determined. For example, for a 10 MHz channel starting at 2110 MHz, a SSB maybe located at the GSCN value of 5279 but not at 5419. For some unlicensed bands, one GSCN is chosen for each 20 MHz sub-channel. From a UE perspective, the UE may have prior knowledge of the previously used sync raster location. But in general, a UE has minimal knowledge about the channelization for a band.

For frequency range 1 (FR1) (frequencies below 7.125 GHz (approximately)), the set of SCS that can be used for the SSB is 15 kHz and 30 kHz. For FR2 (frequencies above 24.25 GHz (approximately)), the set of SCS that can be used for the SSB is 120 kHz and 240 kHz. It was recently agreed to use 480 kHz and 960 kHz for new bands in FR2-2 (frequencies above 60 GHz (approximately)).

TABLE 1
Relation between frequency band and GSCN (partial
listing from Table 5.4.3.3-1 in TS 38.104)

| NR operating | SS Block | SS Block | Range of GSCN |
|---|---|---|---|
| band | SCS | pattern | (First-<Step size>-Last) |
| n1 | 15 kHz | Case A | 5279-<1>-5419 |
| n2 | 15 kHz | Case A | 4829-<1>-4969 |
| . . . | | | |
| n48 | 30 kHz | Case C | 7884-<1>-7982 |

One benefit of the GSCN is that it represents a smaller set of ARFCN. For example, 15 bits can be used to represent the GSCN, while 22 bits are needed for the ARFCN.

TABLE 2
Relation between frequency and GSCN

| Frequency | | Range of | | Range of |
|---|---|---|---|---|
| range, MHz | Formula | variables | GSCN | GSCN |
| 0-3000 | N × 1200 kHz + M × 50 kHz | N = 1, . . . , 2499 | 3N + (M − 3)/2 | 2-7498 |
| | | M ∈ {1, 3, 5} | | |
| 3000-24250 | 3000 MHz + N × 1.44 MHZ | N = 0, . . . , 14756 | 7499 + N | 7499-22255 |
| 24250-100000 | 24250.08 MHz + N × 17.28 MHz | N = 0, . . . , 4383 | 22256 + N | 22256-26639 |

There is a note from TS 38.104 table 5.4.3.1-1 for sub-3 GHz: “The default value for operating bands which only support SCS spaced channel raster(s) is M=3.”

TABLE 3
Obtaining the ARFCN from the GSCN

| Range, MHz | N_{REF} | N | M |
|---|---|---|---|
| 0-3000 | 240N + 10M | 0, . . . , 2499 | 1, 3, 5 |
| 3000-24250 | 600000 + 96N | 0, . . . , 14756 | — |
| 24250-100000 | 2016667 + 288N | 0, . . . , 4383 | — |

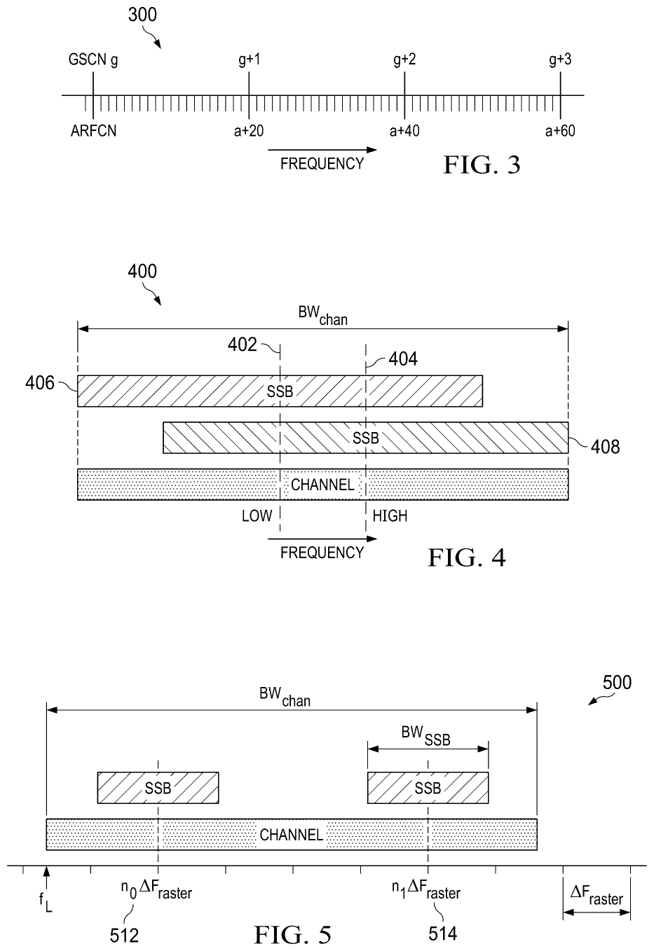

FIG. 3 is a diagram 300 showing how the gth GSCN value is related to the ath ARFCN value for illustration purposes. As shown, the (g+1)th GSCN value is related to the (a+20)th ARFCN value, where 20 is the step size used as an example. Note that based on Table 3, the step size is 20 or 200 (depending on M and N) between successive GSCN values for frequencies below 3 GHz. For frequencies above 24.25 GHz, the step size is 288.

To obtain the frequency from the ARFCN (NREF) in MHz, the following formula can be used:

$$F = \{ \begin{matrix}0.005 {N}_{REF} & 0 \leq {N}_{REF} < 600 , 000 \\ 3 , 000 + 0.015 ( {N}_{REF} - 600 , 000 ) & 600 , 000 \leq {N}_{REF} < 2 , 016 , 667 \\ 24250.8 + 0.06 ( {N}_{REF} - 2 , 016 , 667 ) & 2 , 016 , 667 \leq {N}_{REF} < 3 , 279 , 165\end{matrix} \qquad ( 1 )$$

In NR, the possible frequency locations of the SSBs for initial access are governed by the sync raster. The procedure of how to compute the set of allowable sync raster locations within a band is captured in clause 4.3.1.5 of TR 38.817-01, which is incorporated by reference in its entirety. It is assumed that for a given channel within a band, there is at least one valid sync raster location within that channel. A valid sync raster location within a channel is where a SSB is fully contained in the bandwidth of the channel and where the frequency center of the SSB is on a sync raster location that is predefined.

Based on analysis, under certain conditions, the above assumption (i.e., there is at least one valid sync raster location for a given channel) may not hold true. In an arbitrary channel, there may be several sync raster locations that a network can use to transmit an SSB. However, when considering the guard bands, the bandwidth of the channel, and the bandwidth of the SSB, it may not be possible to find a sync raster location within the channel where the SSB is fully contained and where the center of the SSB is located on the sync raster.

To illustrate this situation, consider an example, where a SSB is transmitted in a 5 MHz channel with a SCS of Δf=15 kHz used for the SSB, and the sync raster spacing (a distance between two adjacent sync raster locations) ΔFᵣₐₛₜₑᵣ is 1.2 MHz (sub 3 GHz). The bandwidth of the SSB, BW_{SSB}, is given by

$${BW}_{SSB} = 2 G + Δ f ( {N}_{RB} {N}_{RB}^{RE} + 1 ) , \qquad ( 2 )$$

Where, as an example, N_{RB}=20 is the number of RBs for the SSB, N_{RB}^{RE}=12 is the number of REs (subcarriers) per RB in the frequency dimension/domain, and the guard band G for the 15 kHz SCS and 5 MHz channel is 242.5 kHz. Note that the number of RBs can also indicate the span in the frequency domain. Substituting these numbers into equation (2), BW_{SSB} is 4100 kHz. FIG. 4 is a diagram 400 illustrating possible locations of the SSB within the 5 MHz channel for 15 kHz SCS. FIG. 4 shows two possible SSBs 406, 408, where frequency locations of the SSBs 406 and 408 are aligned to the channel edges. Dashed vertical lines 402 and 404 indicate the frequency centers of the SSBs 406 and 408, respectively. The dashed line 402 is the center of the left (low) SSB 406, and the dashed line 404 is the center of the right (high) SSB 408.

As described above, if the SSB (occupying 20 RBs) can be completely contained within the bandwidth of the channel, and centered on a predefined sync raster, then there is a valid sync raster for the SSB in the channel, and the SSB can be placed in the channel for transmission. With a valid SSB location, there is a sync raster location where the span of the SSB is within the channel. Thus, taking FIG. 4 as an example, with a valid sync raster location, the SSB will be placed between center locations of the two SSBs 406 and 408. In other words, the valid sync raster location would be between the dashed lines 402 and 404 in FIG. 4. The problem is, among the allowable sync raster locations within a channel, there may not be a sync raster location which satisfies the placement of the SSB within that channel. If the distance (in frequency) between the two lines 402 and 404 is greater than or equal to the raster spacing, there will always be at least one valid sync raster location for that channel. If the distance (in frequency) is less than the raster spacing, sometimes there will be a valid sync raster location for that channel; while sometimes, there will not be a valid sync raster location for that channel. Conditions for when there is no valid sync raster location existing may be determined.

When considering the difference between the channel bandwidth (5 MHz) and SSB bandwidth (4100 kHz), the difference of 900 kHz is less than the sync raster spacing of 1.2 MHz (1200 kHz). With this raster granularity, there appears to be 25% chance of being unable to find a sync raster location that meets the requirements of placing the SSB in the channel, where the value of 25% is based on (1-900 kHz/1200 kHz) and assumption that channels are uniformly distributed in location (starting frequency). Note that an analysis may refine that value.

There may be two problems, as listed below:
whether there are conditions that may be used to determine when no valid sync raster location for a channel based on the current set of GSCNs for the channel in the band is possible.
if there is no valid sync raster location for the channel, how can the SSB be placed in that channel so that a UE can detect the SSB.

Although these are general problems, their solutions may have various applications. One application may be for Reduced complexity (RedCap) UEs that can only support 5 MHz channels and defining sync raster locations for the Rel-18 work item description (WID) on “NR support for dedicated spectrum less than 5 MHz for FR1”, as described in RP-213603. This is also a general problem for any small bandwidth channel or possible enhancements of RedCap UEs.

Another application may be for irregular channel bandwidths. In NR, the bandwidths of the channels for FR1 are 5, 10, 15, 20, 25, 30, 40, 50, 60, 70, 80, 90, and 100 MHz. Note that with a 15 kHz SCS spacing, channel bandwidths of 60, 70, 80, 90, and 100 MHz are not allowed due to the fast Fourier transform (FFT) exceeding 4096 points. Some operators are considering how to deploy NR channels when they have 7 or 12 MHz channels and channels less than 5 MHz.

The following analysis is for a general sync raster spacing scenario considering consecutive sync raster locations. The 50, 150, and 250 kHz offsets for sub-3 GHz (Table 2 corresponding to M=1,3,5) are omitted for simplifying the expressions. It is first assumed the offset is zero. After the basic formulas/concepts are developed, formulas with offsets are shown.

Since the sync raster indicates the center of the SSB, the first possible location of the sync raster within a channel, which may be indicated by no, satisfies:

$${n}_{0} Δ {F}_{raster} - {f}_{L} mod Δ {F}_{raster} \geq {BW}_{SSB} / 2 , \qquad ( 3 )$$

which is equivalently represented as:

$${n}_{0} \geq \frac{\frac{{BW}_{SSB}}{2} + {f}_{L} mod Δ {F}_{raster}}{Δ {F}_{raster}} . \qquad ( 4 )$$

nₒ is the first instance of N for the channel when the frequency location for the sync raster is obtained using the formula in Table 2 (e.g., N×1200 kHz+M×50 kHz). Equivalently, n0 may be used to represent the first possible frequency location of the sync raster within the channel. fL represents the lowest frequency of the channel. The number n0 may be positive. The term (ΔFᵣₐₛₜₑᵣ−f_{L} mod ΔFᵣₐₛₜₑᵣ) represents the difference between lower edge of the channel and a sync raster location. A channel may be specified by its center frequency and bandwidth, by a lower frequency (also referred to as a lower edge) and an upper frequency (also referred to as a higher frequency or edge), or by a lower frequency and a bandwidth. The bandwidth is the difference between the upper and lower frequencies, and the center frequency is the mean of the upper and lower frequencies. The lower/higher edge of a channel may also be referred to as lower/higher end of the channel.

Likewise, the last possible sync raster location within a channel, n₁, satisfies:

$${n}_{1} Δ {F}_{raster} + \frac{{BW}_{SSB}}{2} \leq {f}_{L} mod Δ {F}_{raster} + {BW}_{chan} , \qquad ( 5 )$$

which may equivalently be represented as:

$${n}_{1} \leq \frac{{BW}_{chan} + {f}_{L} mod Δ {F}_{raster} - \frac{{BW}_{SSB}}{2}}{Δ {F}_{raster}} \qquad ( 6 )$$

FIG. 5 is a diagram 500 showing the notations used in the analysis above. The first (lowest) possible center frequency for the SSB in the channel is the sync raster location 512, and the last (highest) possible center frequency for the SSB in the channel is the sync raster location 514. Note, the sync raster location used for the SSB can be anywhere in the channel, such as in the middle of the channel. As shown in FIG. 5, in wider bands, the sync raster location used for the SSB can be near either end of the channel.

Thus, in order to always have at least one sync raster location in a channel, the following condition (7) needs to be satisfied (combining (4) and (6)),

$$\frac{\frac{{BW}_{SSB}}{2} + {f}_{L} mod Δ {F}_{raster}}{Δ {F}_{raster}} n \leq \leq \frac{{BW}_{chan} + {f}_{L} mod Δ {F}_{raster} - \frac{{BW}_{SSB}}{2}}{Δ {F}_{raster}} , \qquad ( 7 )$$

which maybe simplified as:

$$Δ {F}_{raster} \leq {BW}_{chan} - {BW}_{SSB} \qquad ( 8 )$$

Thus, according to the condition (8), the difference between channel and SSB bandwidths may need to be greater than the raster spacing to ensure there is at least one valid sync raster location in a channel.

Assuming a uniform random distribution for the lower edge of the channel between two consecutive raster locations, the probability of being unable to find a valid location is

$$P = \{ \begin{matrix}0 , & {BW}_{chan} - {BW}_{SSB} \geq Δ {F}_{raster} \\ 1 - \frac{{BW}_{chan} - {BW}_{SSB}}{Δ {F}_{raster}} , & otherwise\end{matrix} \qquad ( 9 )$$

A condition of no valid location existing in a channel may be when n1<n0, or

$$⌈ \frac{\frac{{BW}_{SSB}}{2} + {f}_{L} mod Δ {F}_{raster}}{Δ {F}_{raster}} ⌉ > ⌊ \frac{{BW}_{chan} + {f}_{L} mod Δ {F}_{raster} - \frac{{BW}_{SSB}}{2}}{Δ {F}_{raster}} ⌋ . \qquad ( 10 )$$

The condition (10) is the check that can be performed when the condition (8) is not satisfied, to determine whether there is a valid sync raster location in a channel. The condition (10) addresses one of the problems to be solved.

The analysis above can be extended to determine formulas for sub-3 GHz. For sub-3 GHz, there are two sets of offsets. The first set offset includes an offset of 150 kHz (corresponding to M=3) from the 1.2 MHz raster spacing, and the second set of offset includes offsets of {50, 150, 250} kHz (corresponding to M=1,3,5) from the 1.2 MHz raster spacing. The note from TS 38.104, table 5.4.3.1-1 and listed after Table 2 above implies that a band may support only M=3 (150 kHz).

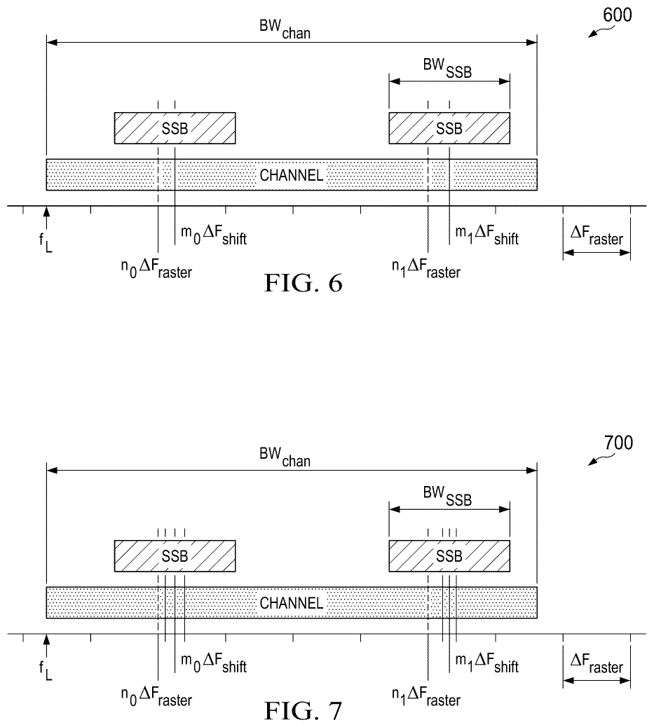

FIG. 6 is a diagram 600 showing notations used for the following analysis with the first set of offsets used.

The first possible location of a sync raster within a channel, n0 and m0, is given by:

$${n}_{0} Δ {F}_{raster} + ( 2 {m}_{0}^{′} + 1 ) Δ {F}_{shift} - {f}_{L} mod Δ {F}_{raster} \geq {BW}_{SSB} / 2 , \qquad ( 11 )$$

where mₒ=3 (corresponding to m₀′=1) and ΔF_{shift}=50 kHz. mₒ is one of the possible values of M in Table 2. Equivalently, the following condition is obtained:

$${n}_{0} \geq \frac{\frac{{BW}_{SSB}}{2} {f}_{L} mod Δ {F}_{raster} - ( 2 {m}_{0}^{′} + 1 ) Δ {F}_{shift}}{Δ {F}_{raster}} \qquad ( 12 )$$

Likewise, the last possible sync raster location within the channel, n1 and m1=3 (corresponding to m₁′=1), is:

$${n}_{1} Δ {F}_{raster} + ( 2 {m}_{1}^{′} + 1 ) Δ {F}_{shift} + {BW}_{SSB} / 2 \leq {f}_{L} mod Δ {F}_{raster} + {BW}_{chan} \qquad ( 13 )$$

which is equivalently represented as:

$${n}_{1} \leq \frac{{BW}_{chan} + {f}_{L} mod Δ {F}_{raster} - \frac{{BW}_{SSB}}{2} - ( 2 {m}_{1}^{′} + 1 ) Δ {F}_{shift}}{Δ {F}_{raster}} . \qquad ( 14 )$$

The condition of no valid sync raster location in a channel is where n₁<n₀, or

$$⌈ \frac{\frac{{BW}_{SSB}}{2} {f}_{L} mod Δ {F}_{raster} - ( 2 {m}_{0}^{′} + 1 ) Δ {F}_{shift}}{Δ {F}_{raster}} ⌉ > ⌊ \frac{{BW}_{chan} + {f}_{L} mod Δ {F}_{raster} - \frac{{BW}_{SSB}}{2} - ( 2 {m}_{1}^{′} + 1 ) Δ {F}_{shift}}{Δ {F}_{raster}} ⌋ . \qquad ( 15 )$$

For BW_{chan}=5 MHz, ΔFᵣₐₛₜₑᵣ=1200 kHz, BW_{SSB}=4100 kHz, ΔF_{shift}=50 kHz, and mₒ=m₁=3, as an example, the condition for no valid location in a channel is:

$$500 < {f}_{L} mod Δ {F}_{raster} < 800. \qquad ( 16 )$$

FIG. 7 is a diagram 700 showing notations used for the following analysis with the second set of offsets used, i.e., for sub-3 GHz and {50, 150, 250} kHz offsets from the 1.2 MHz raster spacing.

Note that mᵢ′={0, 1, 2} corresponds to mᵢ=1, 3, 5 for i=0, 1. To deal with the three possible values of mₒ, the following condition can be used to first find nₒ:

$${n}_{0} Δ {F}_{raster} + ( 2 {m}_{max}^{′} + 1 ) Δ {F}_{shift} - {f}_{L} mod Δ {F}_{raster} \geq {BW}_{SSB} / 2 , \qquad ( 17 )$$

which may also be represented as:

$${n}_{0} \geq \frac{\frac{{BW}_{SSB}}{2} + {f}_{L} mod Δ {F}_{raster} - ( 2 {m}_{max}^{′} + 1 ) Δ {F}_{shift}}{Δ {F}_{raster}} . \qquad ( 18 )$$

Once nₒ is determined, the following is obtained:

$${m}_{0}^{′} = max ( 0 , ⌈ \frac{\frac{{BW}_{SSB}}{2} + {f}_{L} mod Δ {F}_{raster} - {n}_{0} Δ {F}_{raster} - Δ {F}_{shift}}{2 Δ {F}_{shift}} ⌉ ) \qquad ( 19 )$$

Similar to the above analysis for n₁ and m₁ above, the following is obtained:

$${n}_{1} Δ {F}_{raster} + ( 2 {m}_{min}^{′} + 1 ) Δ {F}_{shift} + {BW}_{SSB} / 2 \leq {f}_{L} mod Δ {F}_{raster} + {BW}_{chan} , \qquad ( 20 )$$

which may be equivalently represented as:

$${n}_{1} \leq \frac{{BW}_{chan} + {f}_{L} mod Δ {F}_{raster} - \frac{{BW}_{SSB}}{2} - ( 2 {m}_{min}^{′} + 1 ) Δ {F}_{shift}}{Δ {F}_{raster}} . \qquad ( 21 )$$

When n₁ is determined, the following is obtained:

$${m}_{1}^{′} = max ( 2 , ⌈ \frac{\frac{{BW}_{SSB}}{2} + {f}_{L} mod Δ {F}_{raster} - {n}_{1} Δ {F}_{raster} - Δ {F}_{shift}}{2 Δ {F}_{shift}} ⌉ ) \qquad ( 22 )$$

The condition of no valid location in a channel is when n₁ΔFᵣₐₛₜₑᵣ+(2m₁′+1)ΔF_{shift}<n₀ΔFᵣₐₛₜₑᵣ+(2m₀′+1)ΔF_{shift}, or

$$⌈ \frac{\frac{{BW}_{SSB}}{2} + {f}_{L} mod Δ {F}_{raster} - ( 2 {m}_{max}^{′} + 1 ) Δ {F}_{shift}}{Δ {F}_{raster}} ⌉ > ⌊ \frac{{BW}_{chan} + {f}_{L} mod Δ {F}_{raster} - \frac{{BW}_{SSB}}{2} - ( 2 {m}_{min}^{′} + 1 ) Δ {F}_{shift}}{Δ {F}_{raster}} ⌋ . \qquad ( 23 )$$

For BW_{chan}=5 MHz, ΔFᵣₐₛₜₑᵣ=1200 kHz, BW_{SSB}=4100 kHz, ΔF_{shift}=50 kHz, mₘₐₓ=5 and mₘᵢₙ=1, as an example, the condition for no valid location in a channel is:

$$600 < {f}_{L} mod Δ {F}_{raster} < 700 \qquad ( 24 )$$

Summarizing (10), (16), (24), the “probability of being unable to find a valid sync raster location in a channel” is presented in the last column of Table 4 below. This probability assumes that the lower edge on the channel can be on any frequency. Note that the lower edge of a channel (or equivalently center frequency) typically is on a discrete set of frequencies.

TABLE 4
Conditions for no valid sync raster location

| | | | | | | “Probability” of |
|---|---|---|---|---|---|---|
| | | | | | Range for no valid sync | unable to find a valid |
| Freq, | | | | | raster location (f_{L} and | sync raster location |
| GHz | SCS | M | BW_{chan} | ΔFᵣₐₛₜₑᵣ | ΔFᵣₐₛₜₑᵣ) in kHz | within a channel |
| <3 | 15 kHz | 3 | 5 MHz | 1200 | 500 < f_{L} modΔFᵣₐₛₜₑᵣ < 800 | 25% |
| | | | | kHz | | |
| <3 | 15 kHz | 1, 3, 5 | 5 MHz | 1200 | 600 < f_{L} modΔFᵣₐₛₜₑᵣ < 700 | 8.3% |
| | | | | kHz | | |
| 3 < f < 7 | 15 kHz | n/a | 5 MHz | 1440 | 830 < f_{L} modΔFᵣₐₛₜₑᵣ < 1370 | 37.5% |
| | | | | kHz | | |

To illustrate with an example, consider 5 MHz channelization of band n1 with a first channel at 2110 MHz. The calculation for the check is f_{L} mod ΔFᵣₐₛₜₑᵣ with f_{L} and Fᵣₐₛₜₑᵣ in kHz, and the check for the valid sync raster location is 500<f_{L} mod ΔFᵣₐₛₜₑᵣ<800 (M=3) and 600<f_{L} mod ΔFᵣₐₛₜₑᵣ<700 (M=1,3,5) from Table 4. That is, to check whether there is a valid sync raster location for the channels in the band n1, the values of f_{L} mod ΔFᵣₐₛₜₑᵣ are calculated, and are checked whether they satisfy 500<f_{L} mod ΔFᵣₐₛₜₑᵣ<800 (M=3) and 600<f_{L} mod ΔFᵣₐₛₜₑᵣ<700 (M=1,3,5), according to Table 4. Table 5 below lists the valid sync raster locations in this band, assuming 5 MHz channels are stacked starting from the lowest frequency of the band (e.g., f_{L}^{chan}=f_{L}^{band}+5000 k, where the lowest frequency of a channel (i.e., f_{L}^{chan}) in kHz is a multiple k of 5000 kHz (5 MHz) from the lowest frequency of a band (i.e., f_{L}^{band}). In Table 5, “N” (in the third column) indicates that the calculation for check shows that the corresponding channel (starting at the frequency in the first column) does not have a valid sync raster for the SSB. A “Y” in the third or fourth columns indicates that there is at least one valid sync raster location for the SSB in that channel.

TABLE 5
Examples of 5 MHz channelization for band n1

| | | Check for | Check for |
|---|---|---|---|
| | | Valid sync | Valid sync |
| | Calculation | raster location | raster location |
| Frequency, kHz | for check | (M = 3) | (M = 1, 3, 5) |
| 2,110,000 | 400 | Y | Y |
| 2,115,000 | 600 | N | Y |
| 2,120,000 | 800 | Y | Y |
| 2,125,000 | 1000 | Y | Y |
| 2,130,000 | 0 | Y | Y |
| 2,135,000 | 200 | Y | Y |
| 2,140,000 | 400 | Y | Y |
| 2,145,000 | 600 | N | Y |
| 2,150,000 | 800 | Y | Y |
| 2,155,000 | 1000 | Y | Y |
| 2,160,000 | 0 | Y | Y |
| 2,165,000 | 200 | Y | Y |
| 2,170,000 | 400 | Y | Y |
| 2,175,000 | 600 | N | Y |

As a check of this calculation, Table 6 shows the potential sync raster locations for band n1 in the frequency range of 2,115 MHz to 2,120 MHz. The columns are computed using N=└(GSCN+1)/3┘, M=2(GSCN−3N)+3, N_{REF} is based on Table 3, and the frequency is based on the formula (1). The calculation shows that there is only one valid sync raster location and that location is for M=5. This result is in agreement with the calculation in Table 5 for 2,115,000 mod 1200=600.

TABLE 6
Verification of formulas for sub-3 GHz using band n1 for
2115 to 2120 MHz. Lowest frequency for SSB = 2,117,050
kHz and the highest frequency for SSB = 2,117,950 kHz

| GSCN | N | M | N_{REF} | Frequency, kHz | Valid |
|---|---|---|---|---|---|
| 5288 | 1763 | 1 | 423130 | 2,115,650 | |
| 5289 | 1763 | 3 | 423150 | 2,115,750 | |
| 5290 | 1763 | 5 | 423170 | 2,115,850 | |
| 5291 | 1764 | 1 | 423370 | 2,116,850 | |
| 5292 | 1764 | 3 | 423390 | 2,116,950 | |
| 5293 | 1764 | 5 | 423410 | 2,117,050 | Y |
| 5294 | 1765 | 1 | 423610 | 2,118,050 | |
| 5295 | 1765 | 3 | 423630 | 2,118,150 | |
| 5296 | 1765 | 5 | 423650 | 2,118,250 | |
| 5297 | 1766 | 1 | 423850 | 2,119,250 | |
| 5298 | 1766 | 3 | 423870 | 2,119,350 | |
| 5299 | 1766 | 5 | 423890 | 2,119,450 | |

In the channels for frequencies between 3 and 7 GHz, the set of allowable sync raster locations is currently based on 3 kHz SCS for SSB. Note that 30 kHz SCS is not a criterion for the cases without a valid raster location. As an example for illustration purposes, assume that 15 kHz SCS is used for the SSB and band n48 (3550-3700 MHz) is considered. Band n48 supports 5 MHz channelization. Then, the following Table 7 is generated based on the calculations and checks in Table 4. In Table 7, “N” indicates that the corresponding channel (starting at the frequency in the first column) does not have a valid sync raster for the SSB. “Y” indicates that there is at least one valid sync raster location for the SSB in that channel.

TABLE 7
Example of hypothetical 5 MHz channelization for band n48 and 15 kHz SCS

| | | Check for Valid | | | Check for Valid |
|---|---|---|---|---|---|
| Frequency, | Calculation | sync raster | Frequency, | Calculation | sync raster |
| kHz | for check | location. | kHz | for check | location. |
| 3,550,000 | 400 | Y | 3,625,000 | 520 | Y |
| 3,555,000 | 1080 | N | 3,630,000 | 1200 | N |
| 3,560,000 | 320 | Y | 3,635,000 | 440 | Y |
| 3,565,000 | 1000 | N | 3,640,000 | 1120 | N |
| 3,570,000 | 240 | Y | 3,645,000 | 360 | Y |
| 3,575,000 | 920 | N | 3,650,000 | 1040 | N |
| 3,580,000 | 160 | Y | 3,655,000 | 280 | Y |
| 3,585,000 | 840 | N | 3,660,000 | 960 | N |
| 3,590,000 | 80 | Y | 3,665,000 | 200 | Y |
| 3,595,000 | 760 | Y | 3,670,000 | 880 | N |
| 3,600,000 | 0 | Y | 3,675,000 | 120 | Y |
| 3,605,000 | 680 | Y | 3,680,000 | 800 | Y |
| 3,610,000 | 1360 | N | 3,685,000 | 40 | Y |
| 3,615,000 | 600 | Y | 3,690,000 | 720 | Y |
| 3,620,000 | 1280 | N | 3,695,000 | 1400 | Y |

It is possible to extend the analysis to consider discrete starting (lower edge) frequencies by using the following relationship:

$$( ab ) mod c = ( ( a mod c ) ( b mod c ) ) mod c , \qquad ( 25 )$$

and assuming that the starting frequency is an integer multiple of a step size, such as 1000 kHz. Table 8 examines the conditions in Table 4 for certain starting frequencies, f_{L}.

TABLE 8
Patterns for certain starting frequencies

| Frequency | ΔFᵣₐₛₜₑᵣ = 1200 | | ΔFᵣₐₛₜₑᵣ = 1440 |
|---|---|---|---|
| f_{L}, kHz | 500 < f_{L} mod ΔFᵣₐₛₜₑᵣ < 800 | 600 < f_{L} mod ΔFᵣₐₛₜₑᵣ < 700 | 830 < f_{L} mod ΔFᵣₐₛₜₑᵣ < 1370 |
| 100n | 2 of 12 consecutive | — | 27 of 72 consecutive |
| | values of n will not | | values of n will not |
| | satisfy condition | | satisfy condition |
| 200n | 1 of 6 consecutive values | — | 14 of 36 consecutive |
| | of n will not satisfy | | values of n will not |
| | condition | | satisfy condition |
| 500n | 2 of 12 consecutive | — | 27 of 72 consecutive |
| | values of n will not | | values of n will not |
| | satisfy condition | | satisfy condition |
| 1000n | 1 of 6 consecutive values | — | 14 of 36 consecutive |
| | of n will not satisfy | | values of n will not |
| | condition | | satisfy condition |
| 2000n | — | — | 14 of 36 consecutive |
| | | | values of n will not |
| | | | satisfy condition |
| 5000n | 1 of 6 consecutive values | | 14 of 36 consecutive |
| | of n will not satisfy | | values of n will not |
| | condition | | satisfy condition |

Note that 100n mod 1200={0, 100, . . . , 1100}, 200n mod 1200={0, 200, . . . , 1000}, 500n mod 1200={0, 100, . . . , 1100}, 1000n mod 1200={0, 200, . . . , 1000}, 2000n mod 1200={0, 400, 800}, and 5000n mod 1200={0, 200, . . . , 1000}.

As a check, for Table 5, for a channel with a starting location (starting frequency, lower edge) being a multiple of 5 MHz, the pattern is that 1 of every 6 consecutive starting locations, i.e., one of every 6 channels starting with the 6 consecutive starting locations respectively, does not have a valid sync raster location. With the hypothetical example in Table 7, 11 of 30 starting frequencies do not have a valid sync raster location. This is comparable to the expected 14 out of 36 in Table 8.

There may be two perspectives to consider when there is no valid sync raster location in a channel: network deployment and UE behavior. The UE is generally unaware of the channelization used by the network prior to receiving the SSB.

### Number of RBs for Channels

In some embodiments, using formula (2), the number of RBs of a SSB that can fit into a channel may be computed for several bandwidths, assuming that the guard band for 15 kHz SCS and 5 MHz channel is used, as an example. The assumption is that a UE will reuse the smallest filter. It is noted that in LTE, a 3 MHz channel can support 15 RBs—more than what is calculated in Table 9 below. The guard band is smaller for LTE. Table 9 shows example numbers of RBs of SSBs calculated for various bandwidths, using 242.5 kHz guard band and 15 kHz SCS. Fractional RBs are not allowed in this example (only the integer portion is considered, e.g., if the calculated number of RBs is 13.89, it is truncated to 13).

TABLE 9
Number of RBs assuming 242.5 kHz guard band and 15
kHz SCS. Fractional RBs are not allowed (only the
integer portion is considered, e.g. 13.89 → 13)

| BW, kHz | N_{RB} |
|---|---|
| 3000 | 13 |
| 3100 | 14 |
| 3200 | 15 |
| 3300 | 15 |
| 3400 | 16 |
| 3500 | 16 |
| 3600 | 17 |
| 3700 | 17 |
| 3800 | 18 |
| 3900 | 18 |
| 4000 | 19 |
| 4100 | 20 |
| 4200 | 20 |
| 4300 | 21 |
| 4400 | 21 |
| 4500 | 22 |
| 4600 | 22 |
| 4700 | 23 |
| 4800 | 23 |
| 4900 | 24 |

### Reuse Existing Sync Raster

### 1. No Solution Needed

If the conditions for the cases without a valid sync raster location are not met, then the current sync raster location is valid for the channel. No changes in network deployment or UE behavior are needed.

### 2. Truncated SSB

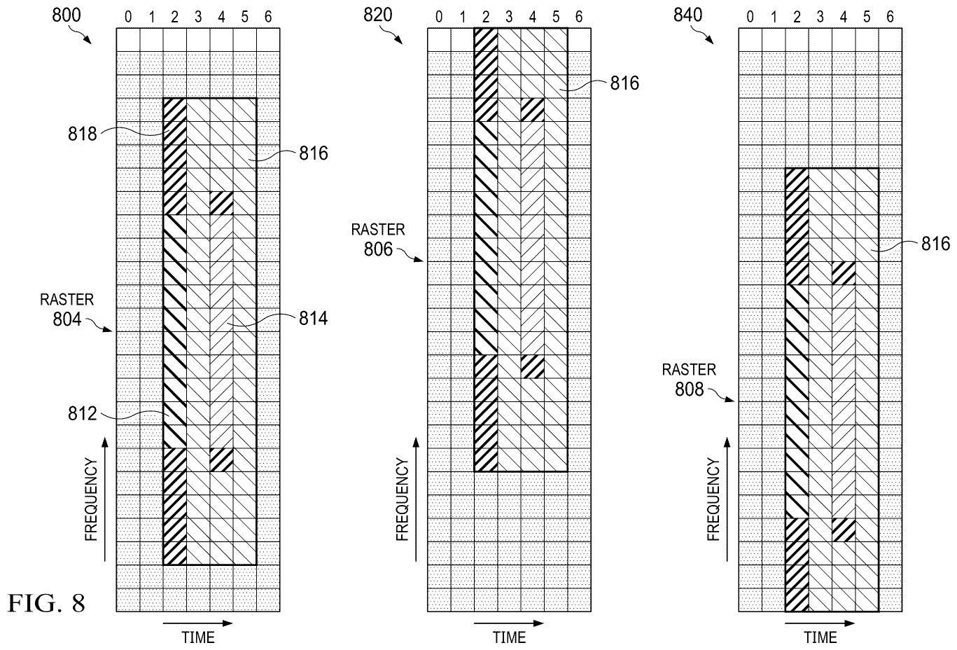

If the conditions for the cases without a valid raster location are met, in some embodiments, the network can transmit a truncated SSB. For example, for FR1 and 1200 kHz raster spacing, the network may transmit a subset of a 20 RB SSB, as illustrated in FIG. 8. FIG. 8 shows an example SSB and truncation of the SSB based on sync raster locations within channels. In FIG. 8, boxes 812 represent the PSS (occupying 10 RBs), boxes 814 represent the SSS (occupying 10 RBs), and boxes 816 represent the PBCH. In this example, the number of RBs in the channels is 25 RBs (dotted boxes and the blank boxes), and the number of RBs in CORESET #0 is 24 RBs (dotted boxes). The 24 RBs maybe an initial downlink BWP used for initial access, and the blank boxes may represent RBs not used during the initial access. Note that using 10 RBs for the PSS and SSS is merely for illustration purposes to illustrate the alignment to the center of the SSB. The SSS and PSS each occupy 127 REs, which is slightly more than 10 RBs. With a total of 8+9 null subcarriers (a null subcarrier (e.g., unoccupied subcarrier) is a RE that has a complex value of o) surrounding the SSS/PSS, the 144 REs are equivalent to 12 RBs. Boxes 818 represent unoccupied RBs. Although FIG. 8 shows that the sync raster is aligned to the RBs used for the CORESET (RE #0 is aligned), it is not required. The diagram 800 of FIG. 8 shows a regular SSB (not truncated) having the PSS at symbol #2, the SSS at symbol #4, and the PBCH. In the frequency domain, the start of the bandwidth part (BWP) containing CORESET #0 is based on an offset from the start of the SSB. The center of the SSB, 804, in the diagram 800 is on RE #0 of RB12. The start of the SSB is RE #0 of RB2. The start of the BWP containing CORESET #0 (initial DL BWP) is 2 RBs lower in frequency from the start of the SSB, and this start of the BWP corresponds to having an offset of 2 RBs in Table n1 below. For a 20 RB SSB, the second and fourth symbols of the SSB have 20 RBs for the PBCH. In the third symbol, the lower (in frequency) 4 RBs and upper 4 RBs are used for the PBCH.

The diagram 800 shows a channel (e.g., 5 MHz) having a sync raster location shown by 804, and the SSB is centered at the sync raster location 804 in the frequency domain. In the diagram 800, the SSB (20 RBs) located at the sync raster location 804 can be completely contained in the channel (24 RBs or 25 RBs). The diagram 820 of FIG. 8 shows a channel with a sync raster located at 806. To center the SSB at the sync raster location 806, the SSB is truncated in the frequency domain. In the diagram 820, the sync raster location 806 (compared with the sync raster 804) is 3 RBs higher in frequency. Because the entire 20 RB SSB, if centered at 806, is not completely contained in the channel (24 RBs or 25 RBs), the SSB can be truncated (punctured). This truncated SSB has 19 RBs, resulting in a total of 3 fewer RBs for the PBCH. Note that more RBs can be truncated. As the diagram 820 shows that, with a 24 RB initial DL BWP (smaller than 25 RBs), only 18 RBs of the SSB are contained in the initial DL BWP. Note that the RBs containing the SSS and PSS are not punctured in this example. There is a potential performance loss in decoding the MIB due to using 3 fewer RBs for the PBCH. Note this corresponds to having an offset of 5 RBs in Table n1. The diagram 840 of FIG. 8 shows a channel with a sync raster located at 808. To center the SSB at the sync raster location 808 while ensuring the PSS and SSS are within the channel, the SSB is truncated in the frequency domain. In the diagram 840, the sync raster location 808 is 3 RBs lower in frequency compared with the sync raster location 804. This truncated SSB has 19 RBs, resulting in a total of 3 fewer RBs for the PBCH. Note this corresponds to having an offset of −1 RBs in Table n1. With truncation, conceptually 20 RBs are reserved for the SSB. But one or more RBs are punctured—the one or more RBs are not transmitted by the base station. The receiver at the UE may assume no signals/channels are transmitted in the one or more RBs not transmitted.

Thus, in some embodiments, if a sync raster location in a channel is located at a frequency location such that a SSB cannot be completely contained in the bandwidth of channel, the SSB may be truncated. For example, the SSB may be aligned to the sync raster location in the channel, and one or more RBs of the SSB that are outside of the bandwidth of the channel maybe truncated/punctured, as shown in diagrams 820 and 840 of FIG. 8.

Table 10 below lists example minimum number of RBs X_{RB} of the SSB to be punctured for different channel bandwidths, when truncation is applied. Note that the minimum size for a truncated SSB maybe 12 RBs, which can correspond to the length of the SSS and PSS with null subcarriers in the frequency domain.

TABLE 10
Minimum number of RBs to puncture based on Table 9, assuming
a 20 RB SSB with a 242.5 kHz guard band and 15 kHz SCS

| BW, kHz | X_{RB} |
|---|---|
| 3000 | 7 |
| 3100 | 6 |
| 3200 | 5 |
| 3300 | 5 |
| 3400 | 4 |
| 3500 | 4 |
| 3600 | 3 |
| 3700 | 3 |
| 3800 | 2 |
| 3900 | 2 |
| 4000 | 1 |
| 4100 | 0 |
| 4200 | 0 |
| 4300 | — |
| 4400 | — |
| 4500 | — |
| 4600 | — |
| 4700 | — |
| 4800 | — |
| 4900 | — |

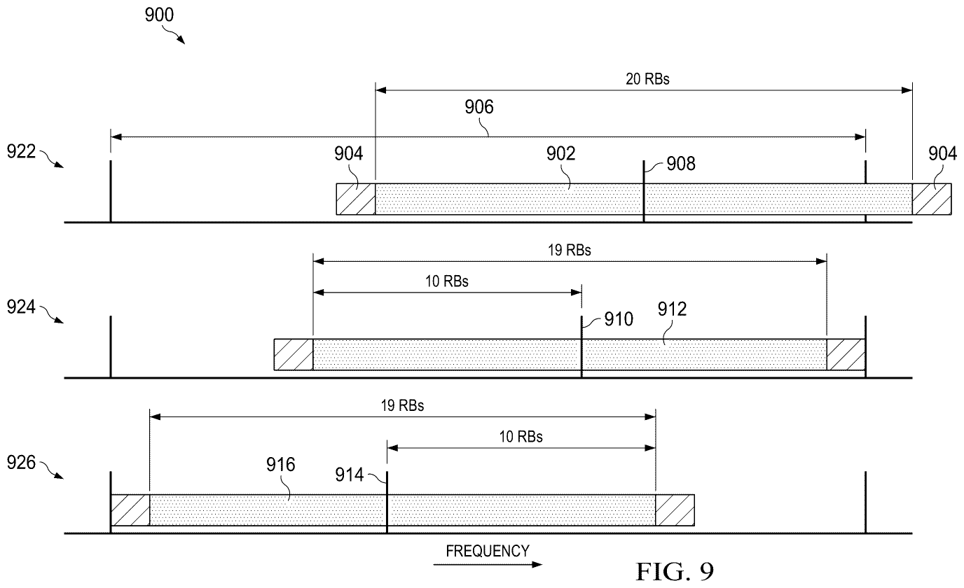

FIG. 9 is an alternate view of FIG. 8 while including guard bands. FIG. 9 shows an example SSB 902 with guard bands 904 and truncation of the SSB 902 based on sync raster locations within a channel having a bandwidth 906. Note that in descriptions of the embodiments of the present disclosure, a 5 MHz channel is used merely for illustration purposes. Embodiments of the present disclosure are also applicable to channels with a bandwidth smaller than 5 MHz, e.g., a channel of 3 MHz. A diagram 922 of FIG. 9 shows the full sized SSB 902 occupying 20 RBs, which exceeds the bandwidth of the channel when the sync raster location within the channel is at frequency location 908. The SSB 902 crosses the thick black line on the right (i.e., the right edge of the channel 906). The line 908 (the sync raster location) may be in the center of the SSB. So the channel cannot completely contain the SSB 902 at the sync raster location 908. The sync raster location 908 is not a valid sync raster location for the SSB 902. In a diagram 924, when the sync raster location is located at a frequency location 910, a truncated SSB 912 with 19 RBs may be used for the channel, where the highest frequency edge of the truncated SSB is aligned to the channel edge. In some instances, there maybe some gap between the SSB edge and channel edge. In some embodiments, the alignment of the SSB with the channel edge may be at the lower edge of the channel. As an example, in a diagram 926 of FIG. 9, when the sync raster location is located at a frequency location 914, a truncated SSB 916 with 19 RBs may be used. It is possible to drop (puncture) the first RB of the SSB 902. The puncturing can be in REs or one or more RBs.

In order to support such a truncation/puncturing, it may be necessary to modify/introduce new tables to map the relationship between the start of the BWP containing CORESET #0 (its bandwidth in RBs and the offset) and the start of the SSB. In the frequency domain, the start of the bandwidth part (BWP) containing CORESET #0 is based on an offset from the start of the SSB. The frequency span of the initial DL BWP can be represented by the number of RBs for CORESET #0. Parts of the current table (Table 13-1 in 38.213) are presented in Table n1 below. For a 24 RB CORESET #0 (5 MHz BW for 15 kHz SCS), the possible locations of the SSB are within the span of the 24 RB CORESET #0. As shown in the diagram 820 of FIG. 8, new entries of offset values (between the start of the BWP containing CORESET #0 and the start of the SSB) of 5 and 6 may be introduced. Likewise for the diagram 840 of FIG. 8, new entries of offset values of −1 and −2 may be introduced. Although 1 or 2 RBs of the SSBs may be outside a CORESET #0 bandwidth (initial DL BWP), a UE can use truncate processing to account for those RBs outside the CORESET #0 bandwidth. It is noted in 38.213 clause 13 that: “For operation without shared spectrum channel access, a UE assumes that the offset in Tables 13-1 through 13-10 is defined with respect to the SCS of the CORESET for Type0-PDCCH CSS set, provided by subCarrierSpacingCommon, from the smallest RB index of the CORESET for Type0-PDCCH CSS set to the smallest RB index of the common RB overlapping with the first RB of the corresponding SS/PBCH block. In Tables 13-7, 13-8, and 13-10 k_{SSB} is defined in [4, TS 38.211].”

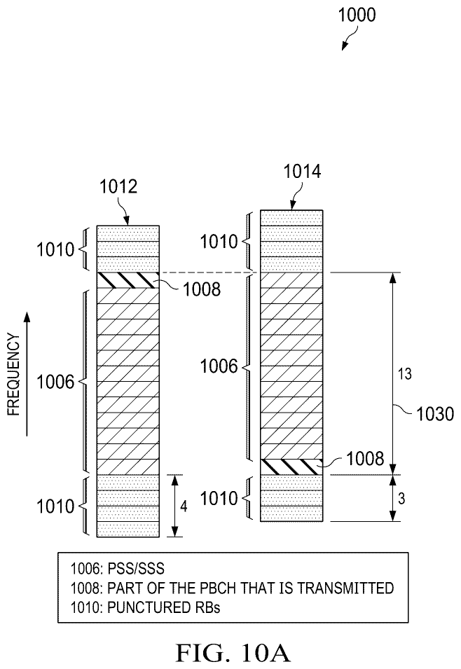

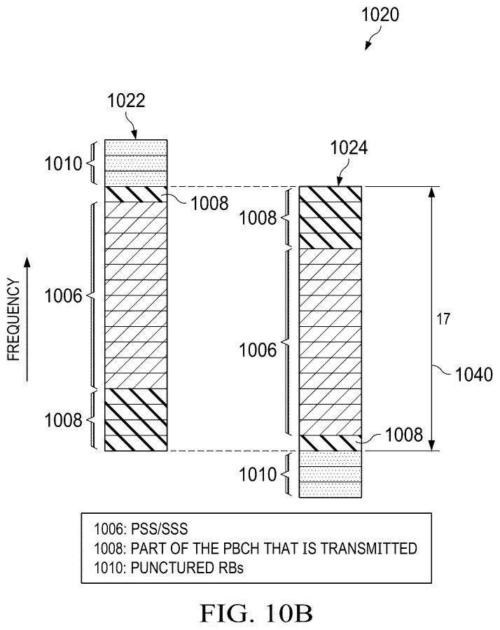

Given that the intent of truncation is to place the SSS/PSS within the channel, the first RBs (i.e., RBs having the lowest frequency occupied by the SSB) or last RBs (i.e., RBs having the highest frequency occupied by the SSB) of the SSB block can be outside the channel. FIG. 10A and FIG. 10B illustrate positions of the SSS/PSS with respect to CORESET #0 for different RBs sizes and channel bandwidths. FIG. 10A is a diagram 1000 showing examples for a channel 1030 of 3000 kHz with 13 RBs, and FIG. 10B is a diagram 1020 showing example for a channel 1040 of 3600 kHz with 17 RBs. Blocks 1006 represent the PSS and the SSS of a 20-RB SSB, blocks 1008 represent the PBCH of the SSB that are within the channel (i.e., transmitted). Blocks 1010 show the truncated/punctured RBs of the SSB (not transmitted). For a base station transmitting the SSB in the channel 1030 having the bandwidth of 13 RBs, the SSB may be truncated as shown by the truncated SSB 1012 or the truncated SSB 1014 in FIG. 10A. For a base station transmitting the SSB in the channel 1040 having the bandwidth of 17 RBs, the SSB may be truncated as shown by the truncated SSB 1022 or the truncated SSB 1024 in FIG. 10B.

There are several tradeoffs to consider in truncating SSBs, and one is to minimize the amount of puncturing (reduce the degradation of PBCH performance) while keeping the same sync raster location, if possible.

Clause 7.4.3.1 in TS 38.211 indicates how the 240 REs within the 20-RB SSB are arranged. The numbering is o based. Clause 7.4.3.1 in TS 38.211 specifies:
First symbol of SSB block: REs {56, 57, . . . , 182} are for PSS, and REs {o, 1, . . . , 55} and {183, 184, . . . , 239} are set to 0
Second and fourth symbols of SSB block: REs {0, 1, . . . , 239} are for PBCH
Third symbol of SSB block: REs {56, 57, . . . , 182} are for SSS; REs {48, 49, . . . , 55} and {183, 184, . . . , 191} are set to o, and REs {0, 1, . . . , 47} and {192, 193, . . . , 239} are for PBCH.

With truncation/puncturing, the above arrangement may change. Let the total number of punctured RBs be denoted as XRB and X1_{RB} be the number of RBs punctured before the starting location of the PSS/SSS and X2_{RB} be the number of RBs punctured after the last location of the PSS/SSS, with X1_{RB}+X2_{RB}=X_{RB}. Using N_{sc}^{RB}=12 to denote the number of subcarriers (REs) per RB, as an example, a general representation of a SSB with puncturing may be:
First symbol of SSB block: REs {56, 57, . . . , 182} are for PSS, and REs {0, 1, . . . , 55} and {183, 184, . . . , 239} are set to 0 (this arrangement has no change)
Second and fourth symbols of SSB block: REs {N_{sc}^{RB}X1_{RB}, N_{sc}^{RB}X1_{RB}+1, . . . , N_{sc}^{RB}(20−X2_{RB})−1} are for PBCH and REs {0, 1, . . . , N_{sc}^{RB}X1_{RB}−1} and {N_{sc}^{RB}(20−X2_{RB}), N_{sc}^{RB} (20−X2_{RB})+1, . . . , 239} are set to o
Third symbol of SSB block: REs {56, 57, . . . , 182} are for SSS; REs {48, 49, . . . , 55} and {183, 184, . . . , 191} are set to 0; REs {N_{sc}^{RB}X1_{RB}, N_{sc}^{RB}X1_{RB}+1, . . . , 47} and {192, 193, . . . , N_{sc}^{RB}(20−X2_{RB})−1} are for PBCH; and REs {0, 1, . . . , N_{sc}^{RB}X1_{RB}−1} and {N_{sc}^{RB} (20−X2_{RB}), N_{sc}^{RB} (20−X2_{RB})+1, . . . , 239} are set to 0.

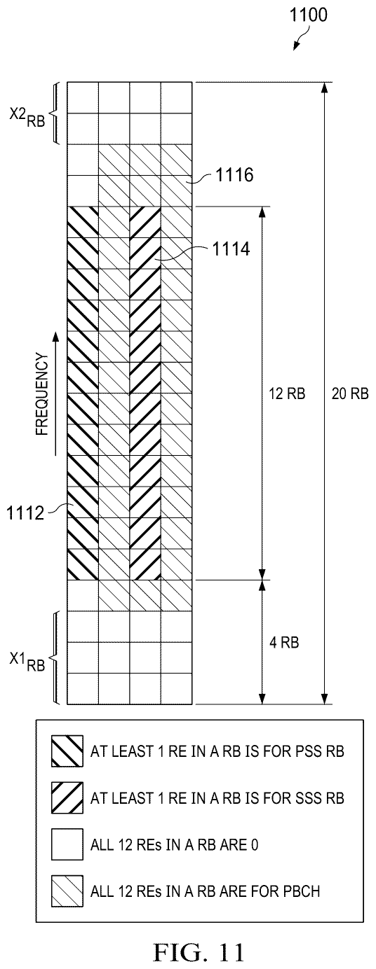

An example with X_{RB}=5, X1_{RB}=2 and X2_{RB}=3 is shown in FIG. 11. FIG. 11 is a diagram 1100 of an example truncated SSB, where 5RBs are punctured from a 20-RB SSB. The truncated SSB includes a 12-RB PSS 1112 at the first symbol, a 12-RB SSS 1114 at the third symbol, and a PBCH 1116 with some RBs truncated. Note that there are several possible values for X1_{RB} and X2_{RB}, e.g., {X1_{R}B X2_{RB}} may have values of {1, 4}, {2, 3}, {3, 2} and {4, 1}. It may be desirable that, when X_{RB}≥4, one term (i.e., either X1_{RB} or X2_{RB}) may be set to 4 so that one side of the SSB is all zeros. It will also simplify the general expressions for specifying the SSB block. When X_{RB}<4, there may be several possible considerations for truncating the SSB, for example, one term (either X1_{RB} or X2_{RB}) may be set to o. One benefit of this setting is simplifying the general expressions for specifying the SSB block.

One observation about specifying the puncturing is that a UE may need to know the size of a truncated SSB in RBs, especially for initial access. One embodiment is that the UE may assume a minimum size, such as 12 (or 13) RBs, for several candidate channel bandwidths and attempt to decode the PBCH accordingly. Another embodiment is that the standard specifies the size of the truncated SSB per channel bandwidth (and band). The UE then knows the size of the truncated SSB and where the punctured REs are located. In Table 11 (right hand side) below, an example for CORESET #0 is provided for 3 MHz channel bandwidth and a 13 RB truncated SSB. The offset values are based on the example of FIG. 10A. For the example of FIG. 10B, the offsets can be 0 to −3.

Another point about Table 13-1 in TS38.213 is the meaning of multiplexing pattern 1 for channels with bandwidths less than 5 MHz. For legacy UEs, the bandwidth of the BWP containing CORESET #0 is greater than bandwidth of the SSB, and the SSB is located within the span of CORESET #0 for multiplexing pattern 1. With channels with bandwidths less than 5 MHz, only the PSS/SSS are located within the span of the BWP containing CORESET #0. The punctured RBs of the SSB are outside the span of the BWP containing CORESET #0.

TABLE 11
Possible CORESET#0 location

| | Current Table | | | Revision of Table 13-1 | | |
|---|---|---|---|---|---|---|
| | 13-1 in 38.213 | | | in 38.213 for 3 MHz | | |
| | Size | # | | Size | # | |
| Index | CORESET#0 | symbols | offset | CORESET#0 | symbols | offset |
| 0 | 24 | 2 | 0 | 13 | 2 | −3 |
| 1 | 24 | 2 | 2 | 13 | 2 | −4 |
| 2 | 24 | 2 | 4 | 13 | 3 | −3 |
| 3 | 24 | 3 | 0 | 13 | 3 | −4 |
| 4 | 24 | 3 | 2 | | | |
| 5 | 24 | 3 | 4 | | | |
| 6 | 48 | 1 | 12 | | | |
| 7 | 48 | 1 | 16 | | | |
| 8 | 48 | 2 | 12 | | | |
| 9 | 48 | 2 | 16 | | | |
| 10 | 48 | 3 | 12 | | | |
| 11 | 48 | 3 | 16 | | | |
| 12 | 96 | 1 | 38 | | | |
| 13 | 96 | 2 | 38 | | | |
| 14 | 96 | 3 | 38 | | | |
| 15 | | | | | | |

There may be three types of truncation: truncate beginning from the highest RB (RB #19) of the SSB; truncate beginning from the lowest RB (RB #0) of the SSB; and truncate the highest and lowest RBs of the SSB. Table 12Table 12 below shows example results of analysis of SSB truncation in a case with a 1200 kHz sync raster spacing and 5 MHz channel (assuming M=3). Table 12 also includes the example where “either 1 RB”—the lowest RB is dropped/punctured or the highest RB is dropped/punctured. In some embodiments, this dropping can be based on cell ID. The cell ID may be obtained after processing the PSS/SSS. As an example, if the cell ID is greater than a specified value in the standard and the result of cell ID modulo 3 is o, the lowest RB is dropped. If the modulo result is 1, then the highest RB is dropped. Otherwise, no truncation is performed. Note that truncating the SSB reduces the probability of unable to find a valid sync raster location within a channel. Another approach is to indicate, in table listing, the set of GSCNs for each band, a UE (of a certain capability/feature) will consider SSBs that can be blind detected/hypothesis tested. Once the SSB is located, the UE (of a certain capability/feature) may examine a table to determine the relation of the SSB to CORESET #0.

It is easy to detect when a network transmits a truncated SSB. From a UE perspective, the standards can indicate whether a channel supports truncated SSB.

TABLE 12
Analysis of truncation for a 1200 kHz sync raster
spacing and 5 MHz channel (assuming M = 3)

| | Lowest | Highest | | “Probability” of |
|---|---|---|---|---|
| | sync | sync | | unable to |
| | raster | raster | | find a valid |
| | position in | position in | | location within |
| Truncation | channel | channel | Difference | a channel |
| Highest 1 RB | 2050 kHz | 3100 kHz | 1050 kHz | 12.5% |
| Lowest 1 RB | 1900 kHz | 2950 kHz | 1050 kHz | 12.5% |
| Highest 2 RBs | 2050 kHz | 3310 kHz | 1260 kHz | 0% |
| Lowest 2 RBs | 1690 kHz | 2950 kHz | 1260 kHz | 0% |
| Either 1 RB | 1900 kHz | 3100 kHz | 1200 kHz | 0% |

If a UE knows whether RBs of the SSB are truncated, the UE may modify its behavior to not consider those RBs during decoding. As an example, the UE may use 0-value log likelihood ratios (LLRs) for channel bits in those RBs that were punctured. A 0-value (zero value) may represent a channel bit that is equally likely to be a binary ‘1’ or binary ‘0’. This may improve performance of decoding the MIB (by assuming a o (zero) value) instead of attempting to decode using poor LLRs. There may have to be new offsets defined in showing the offset relationship between CORESET #0 and the SSB. Another possibility is to use the cell ID to indicate an offset modification between CORESET #0 and the SSB.

It has been known that puncturing changes the code rate. It is possible to estimate (a lower bound) the performance loss with puncturing. To determine the impact with puncturing, the number of channel bits per RB is provided in Table 13, as an example. Note that with a 20-RB SSB, the number of channel bits for the PBCH is 1152 bits (48 RBs×12 RE/RB×2 bits/RE). The coding rate loss due to fewer channel bits is computed using 10 log₁₀ #chan bits/1152.

TABLE 13
Code rate loss for various reduced size SSBs

| | # | Code | | # | Code |
|---|---|---|---|---|---|
| | Channel | rate loss, | | Channel | rate loss, |
| SSB size | bits | dB | SSB size | bits | dB |
| 12 | 576 | 3.01 | 16 | 864 | 1.25 |
| 13 | 648 | 2.50 | 17 | 936 | 0.90 |
| 14 | 720 | 2.04 | 18 | 1008 | 0.58 |
| 15 | 792 | 1.63 | 19 | 1080 | 0.28 |

A 13 RB reduced size SSB (i.e., a SSB reduced to 13 RBs) can fit into the smallest channel size of 13 RBs (3000 kHz), a 13 RB reduced size SSB maybe preferred over a 12 RB SSB due to a 0.5 dB improvement in coding. Likewise, for a channel size of 17 RBs (3600 kHz), using a 17 RB SSB may be preferred for a 2.1 dB improvement in coding over using a 12 RB SSB.

Note there are other approaches to mitigate the performance loss due to puncturing, and some examples are provided in the following:
a) Accumulate multiple reduced size SSBs (implementation approach). A UE receives several reduced-sized (punctured/truncated) SSBs. If the first attempt to decode the PBCH is not successful, the UE may save the log-likelihood ratios (LLRs) associated with the PBCH. When the UE receives the next SSB, it combines the LLRs of the previous SSB(s) and the current SSB and attempts to decode. The UE can repeat this process for other SSBs.
b) Power boosting (implementation approach): A base station changes the power per RE so that certain REs have more power than others under the constraint that the total power in a symbol remains the same. Further description is provided later.
c) Increase the number of SSBs transmitted in a frame. This is a standards approach that can be combined with the accumulation of SSBs and/or power boosting.

With power boosting, the base station can change the power distribution for each RE in a symbol. Assuming there are N_{RB}^{chan} a RBs in the channel, N_{RE}^{RB}=12 REs per RB, and the total power is Pₘₐₓ dB. The power (linear) per RE is:

$${p}_{lin} = {10}^{{P}_{max} / 10} / ( {N}_{RB}^{chan} {N}_{RE}^{RB} ) \qquad ( 26 )$$

If the power were reduced for one set of REs, that amount of power reduction may be distributed to another set of REs. The following provide an example of examining the power reduction in puncturing RBs from the PBCH. It can be easily extended to reducing power of the PSS/SSS.

In this example, it is assumed that the number of RBs for PBCH is N_{RB}^{PBCH}, N_{RB}^{PBCH}≤N_{RB}^{chan}, the number of REs for the PSS/SSS is N_{RE}^{PSS}=127, and the number of RBs occupied by the PSS/SSS and null REs is N_{RB}^{PSS}=12.

Without any power boosting, the power per symbol for the punctured SSB is presented in Table 14. It is assumed that N_{RB}^{chan}<20.

TABLE 14
Power per symbol

| Symbol | |
|---|---|
| 0 | P₀^{sym} = Pₘₐₓ + 10log₁₀ N_{RE}^{PSS}/(N_{RB}^{chan} N_{RE}^{RB}) |
| 1 | P₁^{sym} = Pₘₐₓ + 10log₁₀ N_{RB}^{PBCH}/N_{RB}^{chan} |
| 2 | P₂^{sym} = Pₘₐₓ + 10log₁₀ (N_{RE}^{PSS} + (N_{RB}^{PBCH} − N_{RB}^{PSS})N_{RE}^{RB})/(N_{RB}^{chan} N_{RE}^{RB}) |
| 3 | P₁^{sym} |

For the second symbol and fourth symbol, N_{RB}^{PBCH}N_{RE}^{RB} REs can be boosted by a total chanPBCH PBCH chan of 10 log₁₀ N_{RB}^{chan}/N_{RB}^{PBCH} dB if N_{RB}^{PBCH}<N_{RB}^{chan}. The third symbol has the potential for power boosting of 10 log₁₀ N_{RB}^{PSS} N_{RE}^{RB}/N_{RE}^{PSS}+10 log₁₀ N_{RB}^{chan}/N_{RB}^{PBCH} dB for (N_{RB}^{PBCH}−N_{RB}^{PSS})N_{RE}^{RB} REs. The first term 10 log₁₀ N_{RB}^{PSS}N_{RE}^{RB}/N_{RE}^{PSS} is due to N_{RB}^{PBCH}<N_{RB}^{chan}, and the second term 10 log₁₀ N_{RB}^{chan}/N_{RB}^{PBCH} uses the power not used by the (N_{RB}^{PSS}N_{RE}^{RB}−N_{RE}^{PSS}) zero powered REs. Note that the PSS/SSS is reduced in power, and that extra power may be applied to the third symbol.

### 3. Mapping to Sync Raster

In some cases, even with the use of a truncated/punctured SSB, the current sync raster may not be adequate for locating an SSB within a channel.

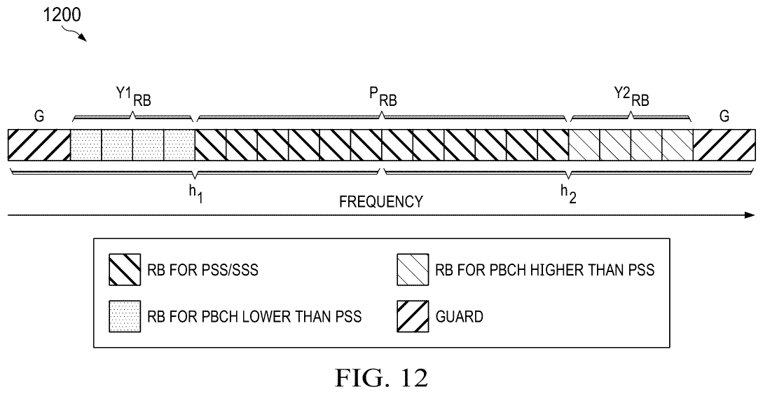

The formulas for locating the raster position may be generalized to include puncturing the PBCH. The following notation is used in the example formulas, as shown in FIG. 12. Let P_{RB}=12 denote the number of RBs for the PSS/SSS, Y1_{RB} denote the number of RBs used for the PBCH that are located at frequencies lower than the PSS/SSS, with 0≤Y1_{RB}≤4, Y2_{RB} denote the number of RBs used for the PBCH that are located at frequencies higher than the PSS/SSS, with 0≤Y2_{RB}≤4, and G represent the guard band. With such notation, Xi_{RB}+Yi_{RB}=4, for i=1, 2, where Xi_{RB} is shown in FIG. 11, representing the truncated RBs.

For convenience, let

$${h}_{1} = G + Δ f ( ( Y {1}_{RB} + \frac{{P}_{RB}}{2} ) {N}_{RB}^{RE} + 0.5 ) and {h}_{2} = G + Δ f ( ( Y {2}_{RB} + \frac{{P}_{RB}}{2} ) {N}_{RB}^{RE} + 0.5 ) .$$

This formulation above allows the puncturing and raster design to be coupled. Using the half RE (the constant term “0.5” in the formulas of h1 and h2) is for math convenience. Some refinement for the actual position may be needed.

It is clear that the formula (7) can be expressed as

$$\frac{{h}_{1} + {f}_{L} mod Δ {f}_{raster}}{Δ {F}_{raster}} \leq n \leq \frac{{BW}_{chan} + {f}_{L} mod Δ {F}_{raster} - {h}_{2}}{Δ {F}_{raster}} , \qquad ( 27 )$$

and that the condition of having no valid sync raster location in a channel is:

$$⌈ \frac{{h}_{1} + {f}_{L} mod Δ {f}_{raster}}{Δ {F}_{raster}} ⌉ > ⌊ \frac{{BW}_{chan} + {f}_{L} mod Δ {F}_{raster} - {h}_{2}}{Δ {F}_{raster}} ⌋ \qquad ( 28 )$$

For the sub 3 GHz frequencies, similar modifications can be made. For M=3, the condition of having no valid location in a channel in formula (15) becomes:

$$⌈ \frac{{h}_{1} + {f}_{L} mod Δ {F}_{raster} - ( 2 {m}_{0}^{′} + 1 ) Δ {F}_{shift}}{Δ {F}_{raster}} ⌉ > ⌊ \frac{{BW}_{chan} + {f}_{L} mod Δ {F}_{raster} - {h}_{2} - ( 2 {m}_{1}^{′} + 1 ) Δ {F}_{shift}}{Δ {F}_{raster}} ⌋ \qquad ( 29 )$$

For M=1,3,5, the condition of having no valid sync raster location in a channel in formula (23) becomes

$$⌈ \frac{{h}_{1} + {f}_{L} mod Δ {F}_{raster} - ( 2 {m}_{max}^{′} + 1 ) Δ {F}_{shift}}{Δ {F}_{raster}} ⌉ > ⌊ \frac{{BW}_{chan} + {f}_{L} mod Δ {F}_{raster} - {h}_{2} - ( 2 {m}_{min}^{′} + 1 ) Δ {F}_{shift}}{Δ {F}_{raster}} ⌋ \qquad ( 30 )$$

For less than 5 MHz channels, using Table 9 and the formula (24), the current sync raster location may not be used to locate the center of the SSB. However, the current sync raster locations may be valid for a truncated SSB. Thus, in some embodiments, conditions of having no valid sync raster location in channels for truncated SSBs may be determined, and checked to determine whether there is a valid sync raster location for a truncated SSB in a channel. Table 15 below shows examples for several bandwidths and truncated SSBs. Table 15 list different channel bandwidths, their associated conditions of having no valid sync raster location, truncation patterns of the PBCH (different values of Y1_{RB} and Y2_{RB}). The condition in Table 15 includes two columns, which is caused bythe modulo operation. The two columns maybe used as logical “or”. In the description, the terms of “puncture pattern”, “puncturing pattern” and “truncation pattern” are used interchangeably.

TABLE 15
Condition for no valid sync raster location when puncturing
the SSB as a function of channel bandwidth

| BW_{chan}, | Punctured | | | | |
|---|---|---|---|---|---|
| kHz | SSB size | Y1_{RB} | Y2_{RB} | Condition | |
| 3000 | 12 | 0 | 0 | 120 < f_{L} mod ΔFᵣₐₛₜₑᵣ < 780 | |
| 3000 | 13 | 0 | 1 | 120 < f_{L} mod ΔFᵣₐₛₜₑᵣ < 960 | |
| 3000 | 13 | 1 | 0 | 0 ≤ f_{L} mod ΔFᵣₐₛₜₑᵣ < 780 | 1140 < f_{L} mod ΔFᵣₐₛₜₑᵣ < 1200 |
| 3600 | 12 | 0 | 0 | 120 < f_{L} mod ΔFᵣₐₛₜₑᵣ < 180 | |
| 3600 | 13 | 0 | 1 | 120 < f_{L} mod ΔFᵣₐₛₜₑᵣ < 360 | |
| 3600 | 14 | 0 | 2 | 120 < f_{L} mod ΔFᵣₐₛₜₑᵣ < 540 | |
| 3600 | 15 | 0 | 3 | 120 < f_{L} mod ΔFᵣₐₛₜₑᵣ < 720 | |
| 3600 | 16 | 0 | 4 | 120 < f_{L} mod ΔFᵣₐₛₜₑᵣ < 900 | |
| 3600 | 13 | 1 | 0 | 0 ≤ f_{L} mod ΔFᵣₐₛₜₑᵣ < 180 | 1140 < f_{L} mod ΔFᵣₐₛₜₑᵣ < 1200 |
| 3600 | 14 | 1 | 1 | 0 ≤ f_{L} mod ΔFᵣₐₛₜₑᵣ < 360 | 1140 < f_{L} mod ΔFᵣₐₛₜₑᵣ < 1200 |
| 3600 | 15 | 1 | 2 | 0 ≤ f_{L} mod ΔFᵣₐₛₜₑᵣ < 540 | 1140 < f_{L} mod ΔFᵣₐₛₜₑᵣ < 1200 |
| 3600 | 16 | 1 | 3 | 0 ≤ f_{L} mod ΔFᵣₐₛₜₑᵣ < 720 | 1140 < f_{L} mod ΔFᵣₐₛₜₑᵣ < 1200 |
| 3600 | 17 | 1 | 4 | 0 ≤ f_{L} mod ΔFᵣₐₛₜₑᵣ < 900 | 1140 < f_{L} mod ΔFᵣₐₛₜₑᵣ < 1200 |
| 3600 | 14 | 2 | 0 | 0 ≤ f_{L} mod ΔFᵣₐₛₜₑᵣ < 180 | 960 < f_{L} mod ΔFᵣₐₛₜₑᵣ < 1200 |
| 3600 | 15 | 2 | 1 | 0 ≤ f_{L} mod ΔFᵣₐₛₜₑᵣ < 360 | 960 < f_{L} mod ΔFᵣₐₛₜₑᵣ < 1200 |
| 3600 | 16 | 2 | 2 | 0 ≤ f_{L} mod ΔFᵣₐₛₜₑᵣ < 540 | 960 < f_{L} mod ΔFᵣₐₛₜₑᵣ < 1200 |
| 3600 | 17 | 2 | 3 | 0 ≤ f_{L} mod ΔFᵣₐₛₜₑᵣ < 720 | 960 < f_{L} mod ΔFᵣₐₛₜₑᵣ < 1200 |
| 3600 | 15 | 3 | 0 | 0 ≤ f_{L} mod ΔFᵣₐₛₜₑᵣ < 180 | 780 < f_{L} mod ΔFᵣₐₛₜₑᵣ < 1200 |
| 3600 | 16 | 3 | 1 | 0 ≤ f_{L} mod ΔFᵣₐₛₜₑᵣ < 360 | 780 < f_{L} mod ΔFᵣₐₛₜₑᵣ < 1200 |
| 3600 | 17 | 3 | 2 | 0 ≤ f_{L} mod ΔFᵣₐₛₜₑᵣ < 540 | 780 < f_{L} mod ΔFᵣₐₛₜₑᵣ < 1200 |
| 3600 | 16 | 4 | 0 | 0 ≤ f_{L} mod ΔFᵣₐₛₜₑᵣ < 180 | 600 < f_{L} mod ΔFᵣₐₛₜₑᵣ < 1200 |
| 3600 | 17 | 4 | 1 | 0 ≤ f_{L} mod ΔFᵣₐₛₜₑᵣ < 360 | 600 < f_{L} mod ΔFᵣₐₛₜₑᵣ < 1200 |

Using Table 15Table 15, it is possible to determine whether there are any valid sync raster locations for certain puncture patterns. For example, with 3600 kHz channel bandwidth in band n100 with a downlink frequency span of (919.4 MHz-923 MHz), 919400 mod ΔFᵣₐₛₜₑᵣ=200. Examining Table 15, a valid sync raster location is possible for 12 RB SSB {Y1_{RB}=0, Y2_{RB}=0}, 13 RB SSB {Y1_{RB}=1, Y2_{RB}=0}, 14 RB SSB {Y1_{RB}=2, Y2_{RB}=0}, 15 RB SSB {Y1_{RB}=3, Y2_{RB}=0} and 16 RB SSB {Y1_{RB}=4, Y2_{RB}=0}. For convenience of description, in the following, SSB {N1, N2} represents SSB {Y1_{RB}=N1, Y2_{RB}=N2}, which indicates the number of RBs punctured before the PSS/SSS and after the PSS/SSS. As another example, for band (936.5-939.5 MHz), 936500 mod ΔFᵣₐₛₜₑᵣ=500. There is no valid sync raster location for 3000 kHz even when the SSB is punctured to either 12 or 13 RBs. As another example, for band (788-791 MHz), 788000 mod ΔFᵣₐₛₜₑᵣ=800. A valid sync raster location for 3000 kHz is possible for either 12 RBs {0, 0} or 13 RBs {1, 0}. The formulation allows selection of a puncturing (or puncture, truncation) pattern that does not impact sync raster design.

For a band without any valid sync raster location, another embodiment examines modification of the raster parameters.

### Changing ΔF_{shift} in the Formulas for <3 GHz

Currently the value of ΔF_{shift} is 50 kHz for frequencies below 3 GHz; implying that the sync raster locations are 1200+{50, 150, 250} kHz for m=1,3,5. For certain bands, it may be possible to re-define ΔF_{shift} to different values. The following provides an example to examine the benefit of re-defining ΔF_{shift}, and analysis is made using ΔF_{shift}=200 kHz and ΔF_{shift}=400 kHz. Substituting ΔF_{shift}=200 kHz into the formula (3) and performing the same analysis for Table 15 produce the following results shown in Table 16.

TABLE 16
Conditions for no valid sync raster location when puncturing the SSB as
a function of channel bandwidth, with ΔF_{shift} = 200 kHz

| BW_{chan}, | | | | |
|---|---|---|---|---|
| kHz | SSB | Y1_{RB} | Y2_{RB} | Condition |
| 3000 | 12 | 0 | 0 | 870 < f_{L} mod ΔFᵣₐₛₜₑᵣ < 930 |
| 3000 | 13 | 0 | 1 | 870 < f_{L} mod ΔFᵣₐₛₜₑᵣ < 1110 |
| 3000 | 13 | 1 | 0 | 690 < f_{L} mod ΔFᵣₐₛₜₑᵣ < 930 |
| 3600 | 12 | 0 | 0 | |
| 3600 | 13 | 0 | 1 | |
| 3600 | 14 | 0 | 2 | |
| 3600 | 15 | 0 | 3 | |
| 3600 | 16 | 0 | 4 | 870 < f_{L} mod ΔFᵣₐₛₜₑᵣ < 1050 |
| 3600 | 13 | 1 | 0 | |
| 3600 | 14 | 1 | 1 | |
| 3600 | 15 | 1 | 2 | |
| 3600 | 16 | 1 | 3 | 690 < f_{L} mod ΔFᵣₐₛₜₑᵣ < 870 |
| 3600 | 17 | 1 | 4 | 690 < f_{L} mod ΔFᵣₐₛₜₑᵣ < 1050 |
| 3600 | 14 | 2 | 0 | |
| 3600 | 15 | 2 | 1 | |
| 3600 | 16 | 2 | 2 | 510 < f_{L} mod ΔFᵣₐₛₜₑᵣ < 690 |
| 3600 | 17 | 2 | 3 | 510 < f_{L} mod ΔFᵣₐₛₜₑᵣ < 870 |
| 3600 | 15 | 3 | 0 | |
| 3600 | 16 | 3 | 1 | 330 < f_{L} mod ΔFᵣₐₛₜₑᵣ < 510 |
| 3600 | 17 | 3 | 2 | 330 < f_{L} mod ΔFᵣₐₛₜₑᵣ < 690 |
| 3600 | 16 | 4 | 0 | 150 < f_{L} mod ΔFᵣₐₛₜₑᵣ < 330 |
| 3600 | 17 | 4 | 1 | 150 < f_{L} mod ΔFᵣₐₛₜₑᵣ < 510 |

Table 16 shows that, for band n100, 919400 mod ΔFᵣₐₛₜₑᵣ=200, there is a valid sync raster location for a 360 kHz channel when any truncated SSB size from 13 to 16 RBs with the exception of 16 RBs {4, 0} is used. For the (936.5-939.5 MHz) band, 936500 mod ΔFᵣₐₛₜₑᵣ=500, there is a valid sync raster location for a 3000 kHz channel when either 12 or 13 RB truncated SSB size is considered. For the (788-791 MHz) band, 788000 mod ΔFᵣₐₛₜₑᵣ=800, there is a valid sync rasterlocation for a 3000 kHz channel when either a 12-RB SSB {0, 0} or a 13-RB SSB {0, 1} is used.

One embodiment is to select ΔF_{shift} per specific bands.

It is possible to consider ΔF_{shift}=400 kHz. However, the derivation of (30) is not applicable with larger values of ΔF_{shift}. However, it is possible use (28) with ΔFᵣₐₛₜₑᵣ=400 kHz.

TABLE 17
Condition for no valid sync raster location when puncturing the SSB as
a function of channel bandwidth, with ΔFᵣₐₛₜₑᵣ = 400 kHz

| BW_{chan}, | Punctured | | | | |
|---|---|---|---|---|---|
| kHz | SSB size | Y1_{RB} | Y2_{RB} | Condition | |
| 3000 | 12 | 0 | 0 | 270 < f_{L} mod ΔFᵣₐₛₜₑᵣ < 330 | |
| 3000 | 13 | 0 | 1 | 0 ≤ f_{L} mod ΔFᵣₐₛₜₑᵣ < 110 | 270 < f_{L} mod ΔFᵣₐₛₜₑᵣ < 400 |
| 3000 | 13 | 1 | 0 | 90 < f_{L} mod ΔFᵣₐₛₜₑᵣ <330 | |
| 3600 | 12 | 0 | 0 | | |
| 3600 | 13 | 0 | 1 | | |
| 3600 | 14 | 0 | 2 | | |
| 3600 | 15 | 0 | 3 | | |
| 3600 | 16 | 0 | 4 | 0 ≤ f_{L} mod ΔFᵣₐₛₜₑᵣ < 50 | 270 < f_{L} mod ΔFᵣₐₛₜₑᵣ < 400 |
| 3600 | 13 | 1 | 0 | | |
| 3600 | 14 | 1 | 1 | | |
| 3600 | 15 | 1 | 2 | | |
| 3600 | 16 | 1 | 3 | 90 < f_{L} mod ΔFᵣₐₛₜₑᵣ < 270 | |
| 3600 | 17 | 1 | 4 | 0 ≤ f_{L} mod ΔFᵣₐₛₜₑᵣ < 50 | 90 < f_{L} mod ΔFᵣₐₛₜₑᵣ < 400 |
| 3600 | 14 | 2 | 0 | | |
| 3600 | 15 | 2 | 1 | | |
| 3600 | 16 | 2 | 2 | 0 ≤ f_{L} mod ΔFᵣₐₛₜₑᵣ < 90 | 310 < f_{L} mod ΔFᵣₐₛₜₑᵣ < 400 |
| 3600 | 17 | 2 | 3 | 0 ≤ f_{L} mod ΔFᵣₐₛₜₑᵣ < 270 | 310 < f_{L} mod ΔFᵣₐₛₜₑᵣ < 400 |
| 3600 | 15 | 3 | 0 | | |
| 3600 | 16 | 3 | 1 | 130 < f_{L} mod ΔFᵣₐₛₜₑᵣ < 310 | |
| 3600 | 17 | 3 | 2 | 0 ≤ f_{L} mod ΔFᵣₐₛₜₑᵣ < 90 | 130 < f_{L} mod ΔFᵣₐₛₜₑᵣ < 400 |
| 3600 | 16 | 4 | 0 | 0 ≤ f_{L} mod ΔFᵣₐₛₜₑᵣ < 130 | 350 < f_{L} mod ΔFᵣₐₛₜₑᵣ < 400 |
| 3600 | 17 | 4 | 1 | 0 ≤ f_{L} mod ΔFᵣₐₛₜₑᵣ < 310 | 350 < f_{L} mod ΔFᵣₐₛₜₑᵣ < 400 |

Using Table 17, as an example, for band n100, 919400 mod ΔFᵣₐₛₜₑᵣ=200, there is a valid sync raster location for a 3600 kHz channel and several RB/puncture patterns. As an example, for the (936.5-939.5 MHz) band, 936500 mod ΔFᵣₐₛₜₑᵣ=100, there is a valid sync raster location for a 3000 kHz channel and a 12 RB SSB. For the (788-791 MHz) band, 788000 mod ΔFᵣₐₛₜₑᵣ=0, and there is a valid sync raster location for a 3000 kHz channel and for either a 12-RB SSB {0, 0} or a 13-RB SSB {1, 0}. There maybe specific values of ΔF_{shift} for certain bands.

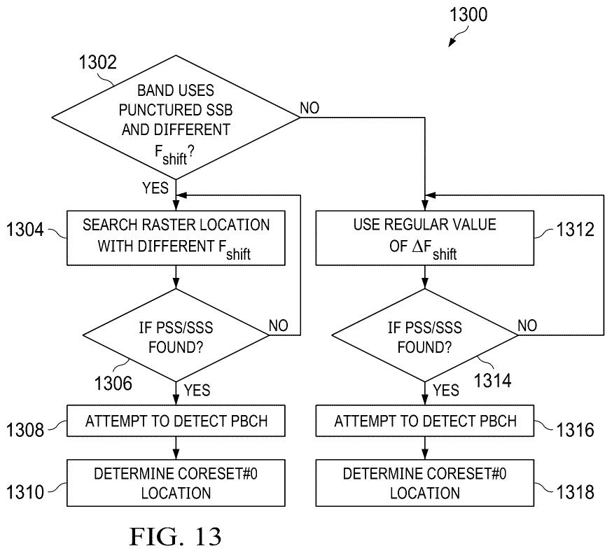

FIG. 13 is a flowchart of embodiment operations 1300 for detecting a SSB in a channel. The method 1300 may be indicative of operations performed by a UE. The UE may determine whether a channel within a band uses a punctured SSB and a different ΔF_{shift} (block 1302). If the UE is capable of operating with a truncated/punctured SSB, when it scans the frequencies for possible SSB locations, the UE may check the band it is monitoring. If the band has a different value of ΔF_{shift} and can use punctured SSB, the UE may search for a SSS/PSS on a sync raster location indicated by the ΔF_{shift} (block 1304). If a PSS/SSS is found (e.g., high correlation) at the sync raster location (block 1306), the UE may start the detection of the PBCH (block 1308). If the location of the punctured RBs is known (e.g., channel/band specific punctured patterns), the UE may assume the log-likelihood ratios (LLRs) for those punctured REs are 0 and begin decoding the PBCH. The UE may accumulate LLRs from several SSBs to increase the quality of the LLRs prior to decoding (keep trying). After the UE decodes the MIB, it can use a table similar to Table 11 (right hand side) to determine parameters (e.g., location) for CORESET #0 and the associated BWP (block 1310). If the PSS/SSS is not found (block 1306), the UE may proceed to block 1304, to search another sync raster location for the PSS/SSS.

If the band does not have a different value of ΔF_{shift} or cannot use punctured SSB, the UE may search for PSS/SSS at a sync raster location indicated by a regular value of ΔF_{shift} (block 1312). If the PSS/SSS is found at the sync raster location (block 1314), the UE may attempt to detect the PBCH (block 1316), and determine, based on MIB obtained from the PBCH, parameters for CORESET #0 (block 1318) and associated BWP. If the PSS/SSS is not found (block 1314), the UE proceeds to block 1312 search the PSS/SSS at another sync raster location if available in the channel.

### Alternate Channels

If the conditions for the cases without a valid sync raster location are met for a channel, in one embodiment, the network may transmit the SSB on another channel. e.g., a channel with a valid sync raster location. In this case, no changes for UE behavior are needed. The term “alternate” used herein can mean used in place of, or in addition to.

From the network perspective, this embodiment may complicate cell frequency deployment because selecting a different channel may not always work considering an operator's spectrum allocation.

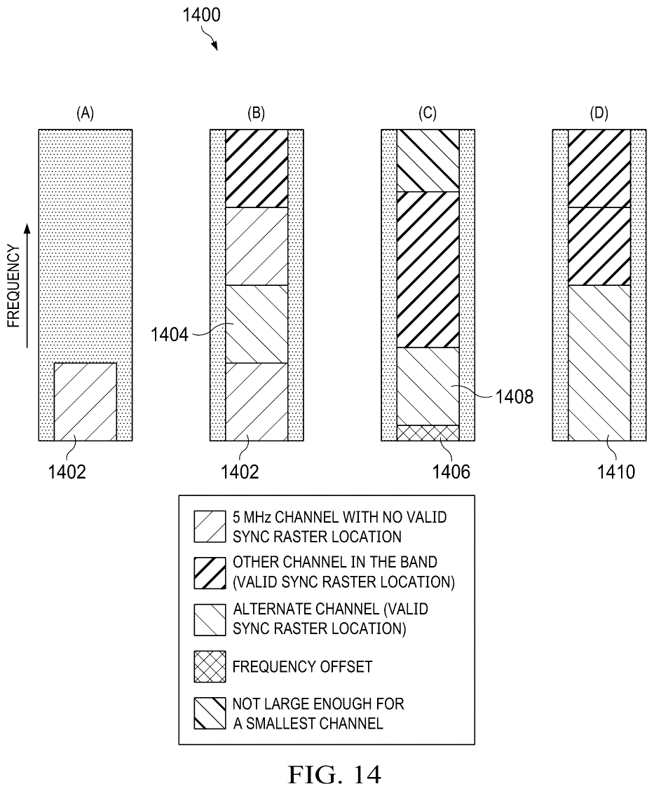

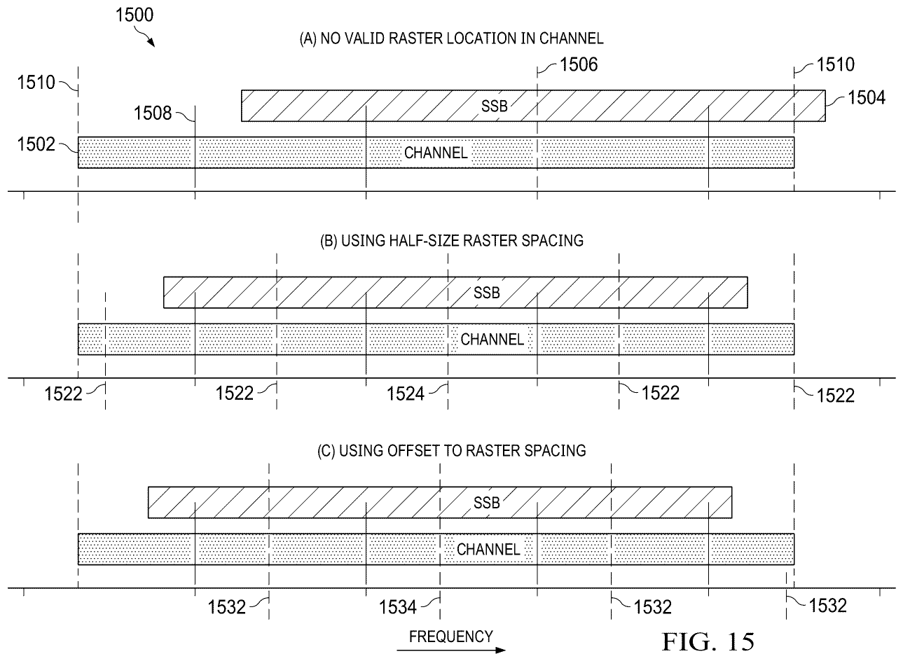

Some approaches of alternate channel selection are shown in FIG. 14. FIG. 14 is a diagram 1400 showing example channels that do not have a valid sync raster locations and example possible channels that may be used. (A) of FIG. 14 shows a first 5 MHz channel 1402 in a 20 MHz band (dotted block), and the channel does not have a valid sync raster location. (B) of FIG. 14 shows a “next channel” of the channel 1402 in the 20 MHz band. In this example, the 20 MHz band may be divided into four 5 MHz channels, and the next channel 1404 of the channel 1402 may be an alternate channel (having a valid sync raster location) of the channel 1402. The network may select the next channel 1404 to transmit the SSB. This is referred to as a next channel approach. (C) of FIG. 14 shows a “shifted channel”. In this example, the channelization is shifted a small amount (a frequency offset 1406), so that a 5 MHz channel (1408) closest to the band edge and with a valid sync raster location is selected for transmitting the SSB. This approach is referred to as a shifted channel approach. (D) of FIG. 14 shows a “larger channel” 1410, which maybe a 10 MHz channel as an example. In this example, instead of using a 5 MHz channel, the network may select the 10 MHz channel for transmitting the SSB. This approach may be referred to as a larger channel approach. In FIG. 14, the channels 1404, 1408 and 1410 show various candidate channels (alternate channels) that may be used to transmit the SSB when the channel 1402 does not have a valid sync raster location for the SSB.

Some observations about the alternate channels shown in (B)-(D) of FIG. 14 are presented in the following.

In (B) of FIG. 14, the next channel approach is simple, but it has a drawback in that when one channel does not have a valid sync raster location, another channel (not necessarily the next channel in frequency) may not have a valid sync raster location. The following provide two examples.

Example 1, assuming 15 kHz SCS with ΔFᵣₐₛₜₑᵣ=1200, a 5 MHz channel and M=3. If f_{L} mod ΔFᵣₐₛₜₑᵣ=600, then the check for the next channel, (i.e., (f_{L}+5000) mod ΔFᵣₐₛₜₑᵣ=800) shows that the next channel does have a valid sync raster location. However, a channel 30 MHz away will not have a valid sync raster location: (f_{L}+30000) mod ΔFᵣₐₛₜₑᵣ=600. This pattern is observed in Table 5.

Example 2: Consider Table 7 where ΔFᵣₐₛₜₑᵣ=1440 kHz and assume f_{L} mod ΔFᵣₐₛₜₑᵣ=840. The next 5 MHz channel will have a valid sync raster location: (f_{L}+5000) mod ΔFᵣₐₛₜₑᵣ=80. If the Table 7 is examined further, there are spans where every other channel does not have a valid sync raster location. This is similar to Table 8.

Note that the relationship

$$( A + B ) mod C = ( A mod C + B mod C ) mod C \qquad ( 31 )$$

can be used to evaluate expressions in the two examples.

The next channel approach may complicate network planning. If a 5 MHz channel is desired to be located in a dedicated portion of a band (edge of the band), and a valid sync raster location is not found in that channel, another channel may need to be used (e.g., middle of the band). In another example for coexistence, in Rel. 17, a RedCap UE that supports a maximum of 20 MHz channels may be introduced. A network operator may want to restrict the Rel-18 RedCap UEs to a certain 5 MHz channel. If that channel does not have a valid sync raster location, the operator would have to consider a different channelization. In a different example, a Rel-18 RedCap UE with 5 MHz BW maybe introduced with 20 MHz RedCap UEs. For existence considerations, the desired 5 MHz channel may not have a valid sync raster location. While an alternate channel can be found in a 20 MHz channel, that channel may not be preferred by the network.

With the shifted channel approach in (C) of FIG. 14, the alternate 5 MHz channel begins at some offset from the original 5 MHz channel (with no valid sync raster location). As an example, for 15 kHz SCS and 1200 kHz raster spacing, Equation (31) can be used to show that an offset of 300+1200 k kHz (<2 RBs for k=0) is sufficient for k≥0 to find a valid sync raster location. However, there are at least two drawbacks in this approach. The first one is that there will be unused spectrum (e.g., 300 kHz plus 4700 kHz on the other end of the band). The second one is that another channel that originally had a valid sync raster location in the band may no longer have a valid sync raster location with the offset. The shifted channel approach may complicate network planning, such as network planning for interference measurements.

The larger channel approach in (D) of FIG. 14 overcomes the shortcomings of the shifted channel and next channel approaches by the network using a larger channel bandwidth, such as 10 MHz, instead of the 5 MHz channel. A larger channel is effectively any channel whose bandwidth exceeds the SSB bandwidth by at least the raster spacing. This implies that with a larger channel, there is always one valid sync raster location. With NR, the next larger channel bandwidth is at least 5 MHz. Using a larger channel than desired may complicate network planning.

### Embodiments: Alternate Sync Raster Locations within a Channel

If the alternate channel approaches are not desired from the network deployment, it may be possible to consider an approach which introduces a valid sync raster location within a channel. In some embodiments, two possible alternate sync raster locations maybe used, which are based on the use of a smaller (or reduced) raster spacing or a displacement (of the sync raster location, or shift/offset). The approach of alternative sync raster locations may be combined with the approach of puncturing SSB to provide a valid sync raster location in a channel for SSB transmissions. The combination will be apparent to those of skill in the art upon reference to the present disclosure. Those of ordinary skill in the art would recognize that various embodiments, modifications and alternatives maybe made without departing from the spirit and scope of this disclosure.

In examining the formula (8), reducing the raster spacing so that the reduced raster spacing is less than or equal to the difference between the channel bandwidth and SSB bandwidth would ensure there is valid sync raster location (with the reduced raster spacing). One example of a reduced raster spacing is to use ΔFᵣₐₛₜₑᵣ′=ΔFᵣₐₛₜₑᵣ/k for k=2, 3, . . . , for certain channels in a band. It is noted that k may have to satisfy other constraints, e.g., for frequencies below 3 GHz in NR, k should perfectly divide 240 (240=raster spacing of 1,200,000 Hz/5000 Hz [finest granularity is 5 kHz]). For frequencies between 3 and 24 GHz, the constraint may be that k should perfectly divide 96. For the band n1 example, the difference in bandwidth between the channel and SSB is 900 kHz. With k=2, if 600 kHz, instead of the 1200 kHz, is used as the raster spacing, there can be a valid sync raster location in a channel with that reduced raster spacing.

With a shifted sync raster, if a channel cannot support a valid sync raster location in the channel, a displacement (or shift, offset) from the set of sync raster locations may allow a SSB to fit within the channel. In some embodiments, one possible displacement maybe a multiple of an RB. For example, with 15 kHz SCS, one RB represents 180 kHz in frequency. With a 1200 kHz raster spacing, a displacement of 2 RBs maybe used (because 900 kHz difference+360 kHz offset (2RBs)>1200 kHz). With a 1440 kHz raster spacing, a displacement of 3 RBs maybe used (because 900 kHz difference+540 kHz offset>=1440 kHz). In general, if the sync raster location is f, then a UE can examine f+Δ. Δ is a displacement value in frequency, and it can be either positive or negative, and can be a positive/negative multiples of RB size. Values of Δ may also be obtained using the equation (31) based on some modulo arithmetic. In some embodiments, the same displacement value (Δ) can be used for FR1, such as 3 RBs. It is noted that 3 RBs is also a possible displacement for frequencies under 3 GHz.

FIG. 15 is a diagram 1500 showing example alternate raster locations for a SSB in a channel. In FIG. 15, (A) shows an example where a 5 MHz channel 1502 does not have a valid sync raster location for the SSB 1504. This can be an example from Table 5, where f_{L} mod ΔFᵣₐₛₜₑᵣ=400 with f_{L}=2,110,000 kHz and ΔFᵣₐₛₜₑᵣ=1200 kHz. The center of the SSB is aligned to the sync raster location 1506. The black vertical lines, e.g., 1508, represent potential sync raster locations in the channel 1502. These sync raster locations 1508 may be pre-defined. The dotted lines 1510 denote the edge of the channel 1502. In this example, the SSB 1504, if located at any sync raster location in the channel 1502, e.g., the sync raster location 1506, crosses the edge of the channel 1502. Thus, there is no valid sync raster location for the SSB 1504 in this channel 1502.

(B) of FIG. 15 shows an example using the embodiment with a smaller raster spacing, with k=2. The lines 1522 and 1524 indicate the additional raster locations introduced in the channel 1502 by using a smaller raster spacing. The center of the SSB 1504 can be aligned to the sync raster location 1524 such that the SSB 1504 is contained in the bandwidth of the channel 1502. Thus, by using the smaller raster spacing, there may be a valid raster location (e.g., 1524) for the SSB 1504 in the channel 1502.

(C) of FIG. 15 shows an example using the embodiment displacement approach, with a shift/offset of 2 RBs. The lines 1532 and 1534 indicate the additional raster locations introduced in the channel 1502 by displacing the sync raster locations 1508 by 2RBs. The center of the SSB 1504 may be aligned to the sync raster location 1534 such that the SSB 1504 is contained in the channel 1502.

From a detectability perspective, the use of the alternate raster location(s) can be detected if the UE supporting this type of sync raster location can successfully perform initial access while a legacy UE is unable to perform initial access.

For a network, using the checks in Table 4, it can be determined whether a channel is able to support a valid sync raster location with the raster spacing as defined in rel. 17 version of the 38.104/38.101-1/38.101-2 standards (or as listed in Table 1). An alternate sync raster location may be used (based on the embodiments) by the network in performing the checking.

Assume a UE knows whether a channel (band) can use an alternate sync raster location. From one perspective there can be two sets of sync raster locations for the UE. The first set, which may be called “legacy”, is based on the rel. 17 version of the sync raster locations. These locations may be defined by Table 2 for a specific band. For example, the first set of sync raster locations for band n1 ranges from 5279 to 5419 in Table 1. The second set of comprises alternate sync raster locations. The second set may be computed from the first set. As an example, for the range 3 to 24 GHz, an alternate sync raster location, when the reduced raster spacing approach is used, is 0.72 MHz (corresponding to raster spacing/2) greater than the frequency corresponding to the raster points from the first set. With the displacement approach, as an example, an alternate sync raster location is 3 RBs (3×180 kHz=540 kHz) greater than the frequency corresponding to the raster locations from the first set. As another example, for the frequency range 0 to 3 GHz, assume M=3 for description convenience. With the reduced raster spacing of 0.60 MHz (corresponding to raster spacing/2), the alternate sync raster location is greater than the frequency corresponding to the raster points from the first set. With the displacement approach, the alternate sync raster location is 2 RBs (2×180 kHz=360 kHz) greater than the frequency corresponding to the raster points from the first set.

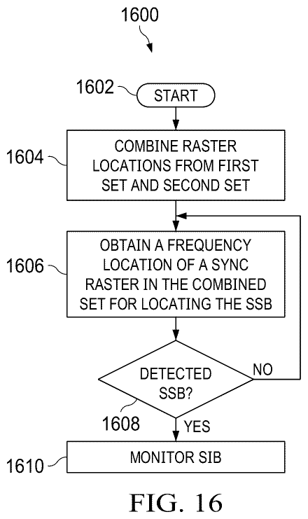

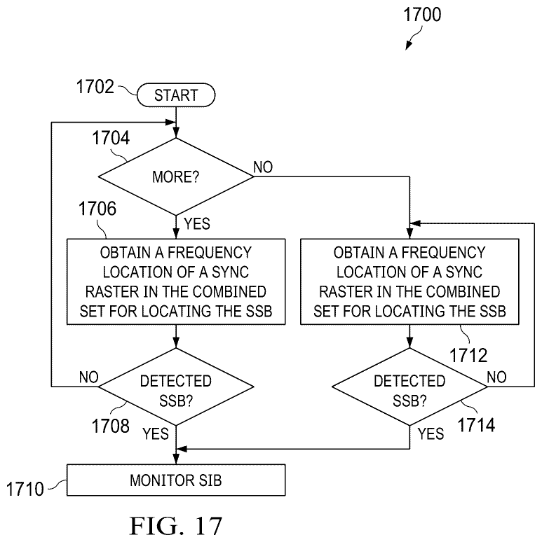

FIG. 16 and FIG. 17 show two example UE behaviors in detecting SSBs when the alternate sync raster locations of SSBs are supported in a 5 MHz channel of a band. It is noted that the order that the UE searches for sync raster locations can be implementation specific. However, with sensors monitoring the received frequencies used by the UE, one can determine the order of frequencies examined. FIG. 16 is a flowchart of embodiment operations 1600 for detecting a SSB in a band. The operations 1600 start from block 1602, and the UE can combine the sync raster locations from both the first set and second set (if the band supports the alternate sync raster locations) (block 1604). The UE may search for the SSB based on that combined set of sync raster locations. The UE may obtain a frequency location of a sync raster location in the combined set for locating the SSB (block 1606). For example, the UE may use Table 1 to select a GSCN, and calculate a frequency corresponding to the GSCN using Table 2. The UE may detect the SSB on the obtained frequency location of the sync raster location (block 1608). For example, the UE may assume that the center frequency of the SSB is at the frequency location of the sync raster location. If the SSB is detected, the UE monitors the SIB based on resource information obtained from the SSB (block 1610). If the SSB is not detected, the UE may proceed to the block 1606 to check another sync raster location for locating the SSB. For example, the UE may use Table 1 to select another GSCN, obtain a corresponding frequency of this GSCN, and detect the SSB based on this frequency. If the UE check all possible sync raster locations in the band and does not detect the SSB, the method stops.

FIG. 17 is a flowchart of another embodiment method 1700 for detecting a SSB in a band. The UE attempts to detect SSB using the frequencies from the first set. If unsuccessful, the UE can search for SSBs using frequencies from the second set if the band support alternate sync raster locations. The method 1700 starts with block 1702, and the UE determines whether there is at least one more sync raster location to be checked in the first set (block 1704). If the answer is yes, the UE obtains a frequency location of a sync raster location to be checked for locating the SSB (block 1706). The UE may then detect the SSB based on the frequency location (block 1708). If the SSB is detected, the UE monitors the SIB based on resource information obtained from the SSB (block 1710). If the SSB is not detected, the UE may proceed to the block 1704 to check the next available sync raster location in the first set. If there are no more sync raster locations to be checked in the first set, the UE may check the second set of sync raster locations if alternative sync raster locations are supported by the band. The UE may obtain a frequency location of a sync raster location in the second set for locating the SSB (block 1712), and detect the SSB based on the frequency location (block 1714). If the SSB is detected, the UE goes to block 1710 to monitor the SIB. If the SSB is not detected, the UE may proceed to block 1712 to check the next sync raster location in the second set for detecting the SSB. If the UE does not detect the SSB after checking all the sync raster locations in the second set, the method 1700 stops.

To apply the alternate sync raster location approach, the standard may need to specify which bands can support an alternate sync raster location. One possible embodiment is to augment the existing sync raster table with a column indicating whether a band supports an alternate sync raster location. If more than one type (e.g., displacement, reduced raster spacing) is used, that type can be captured in the table. Table 18 provides such an example. As shown, a column “Support alternate sync raster locations” is added to show whether a corresponding band supports alternate sync raster locations.

TABLE 18
Relation between frequency band and GSCN (partial
listing from Table 5.4.3.3-1 in TS 38.104)

| NR operating | SS Block | SS Block | Range of GSCN | Support alternate sync |
|---|---|---|---|---|
| band | SCS | pattern (note) | (First-<Step size>-Last) | raster locations |
| n1 | 15 kHz | Case A | 5279-<1>-5419 | Y |
| n2 | 15 kHz | Case A | 4829-<1>-4969 | N |
| . . . | | | | |
| n48 | 30 kHz | Case C | 7884-<1>-7982 | N |

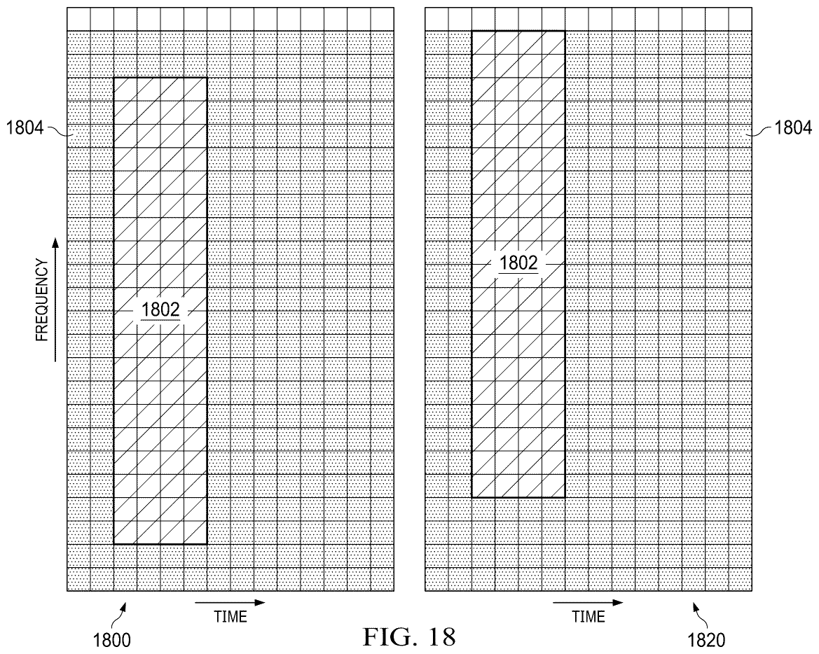

In TS 38.213, clause 13, there are tables indicating the RB offset between the first RE of the SSB and the first RE of CORESET #0. One advantage of the displacement approach is that the shift is known (such as 2 RBs for frequencies under 3 GHz, 3 RBs for frequencies between 3 and 24 GHz). That shift can be incorporated into the formula to the RB offset between the first RE of the SSB and the first RE of CORESET #0. FIG. 18 is a diagram showing example locations of a SSB 1802 (diagonally-lined boxes) and CORESET #0 1804 (dotted boxes) in a time-frequency grid, highlighting a displaced raster location. The diagram 1800 shows a current offset of 2 RBs between the first REs of SSB 1802 and CORESET #0 1804. With the displacement approach used (e.g., using a shift of 2 RBs), the offset will be 4 RBs between the first REs of the SSB 1802 and CORESET #0 1804, as shown by the diagram 1820. However, because the UE knows that this SSB is shifted by 2 RBs, the UE can add 2 to the offset to determine the location of CORESET #0 1804.

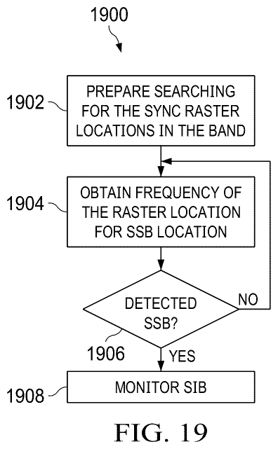

FIG. 19 is a diagram 1900 of embodiment operations at a UE for locating a SSB within a band. The UE may prepare searching for the sync raster locations in the band (block 1902). For example, the UE may obtain information of the GSCNs for the band, using Table 1. Based on the band that the UE is currently operating, the UE may obtain/select a frequency corresponding to the first/next allowable (permitted) GSCN for the band. The selected frequency is a sync raster location, and the UE may obtain the frequency of the sync raster location to search for (to locate) the SSB in the band (block 1904). Note that the GSCNs is a set of integers ranging from 1 to 26639 (Table 2). For a band, there is a range of GSCNs, and the allowable set of GSCNs is a subset of that range. The offset in Table 1 is one parameter used to define the subset.

The UE may attempt to detect the SSB (block 1906), whose center frequency corresponds to the allowable GSCN (i.e., the sync raster location). There may be one or two possible SCS candidates for the SSB. If the UE is unable able to detect an SSB, it may proceed to block 1904 to select another GSCN within the band (i.e., obtain another sync raster location). If there is no more allowable GSCN within the band, the UE may select a different band. If the UE detects the SSB, it may establish the initial DL BWP and subsequently receive the SIB (block 1908) based on the detected SSB.

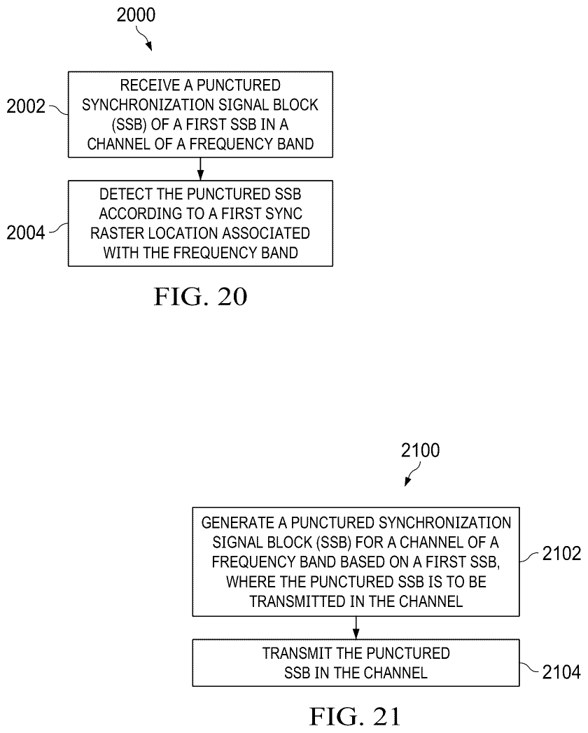

FIG. 20 is a flowchart of an embodiment method 2000 for SSB communication. The method 2000 is indicative of operations of a user equipment (UE). As shown, the UE may receive, from a base station, a punctured synchronization signal block (SSB) of a first SSB in a channel of a frequency band (block 2002). The first SSB may include a first physical broadcast channel (PBCH), a primary synchronization signal (PSS), and a secondary synchronization signal (SSS). The punctured SSB may include a punctured PBCH, the PSS and the SSS. The punctured PBCH may be obtained from the first PBCH by applying a first puncture pattern to the first PBCH to reduce a first number of resource blocks (RBs) of the first PBCH to a second number of RBs for transmission. A center frequency of the PSS of the punctured SSB is indicated by a first sync raster location of a first set of sync raster locations associated with the frequency band, and the first puncture pattern is associated with the first sync raster location. The UE may detect the punctured SSB according to the first sync raster location (block 2004). The punctured PBCH may carry information that is used to determine a frequency location of the channel. As an example, the punctured PBCH may include an index in Table 11. The UE may determine the frequency location of the channel based on information included in the entry corresponding to the index, e.g., an offset. The offset may be related to a difference between the starting frequency location of the channel and the center frequency of the PSS (or a specific RB of the PSS).

FIG. 21 is a flowchart of an embodiment method 2100 for SSB communication. The method 2100 is indicative of operations of a base station. As shown, the base station may generate a punctured synchronization signal block (SSB) for a channel of a frequency band based on a first SSB, where the punctured SSB is to be transmitted in the channel (block 2102). The first SSB includes a first physical broadcast channel (PBCH), a primary synchronization signal (PSS) and a secondary synchronization signal (SSS), and a bandwidth of the first SSB exceeds a bandwidth of the channel. The punctured SSB includes a punctured PBCH of the first PBCH, the PSS and the SSS. The punctured PBCH may be obtained from the first PBCH by applying a first puncture pattern to reduce a first number of resource blocks (RBs) of the first PBCH to a second number of RBs for transmission. A center frequency of the PSS of the punctured SSB is indicated by a first sync raster location of a first set of sync raster locations associated with the frequency band, and the first puncture pattern is associated with the first sync raster location. The base station may transmit the punctured SSB in the channel, e.g., to a UE (block 2104). The first SSB maybe punctured as described in the embodiments above.

Embodiments of the present disclosure enable communication of synchronization signal blocks in a channel having a small bandwidth, e.g., a bandwidth less than or equal to 5 MHz, and enable supporting wireless communications of devices operating in small bandwidths.

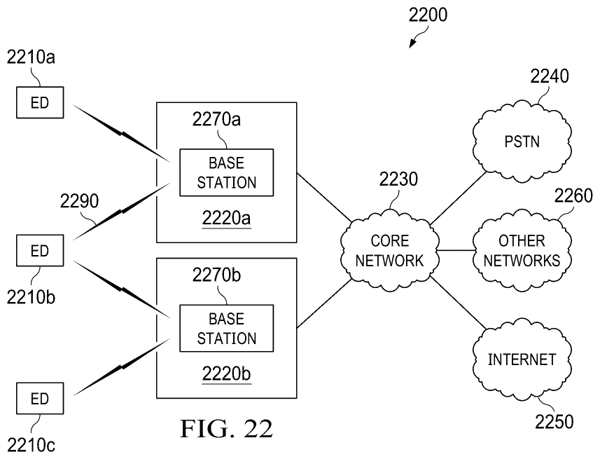

FIG. 22 illustrates an example communication system 2200. In general, the system 2200 enables multiple wireless or wired users to transmit and receive data and other content. The system 2200 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 2200 includes electronic devices (ED) 2210a-2210c, radio access networks (RANs) 2220a-2220b, a core network 2230, a public switched telephone network (PSTN) 2240, the Internet 2250, and other networks 2260. While certain numbers of these components or elements are shown in FIG. 22, any number of these components or elements may be included in the system 2200.

The EDs 2210a-2210c are configured to operate or communicate in the system 2200. For example, the EDs 2210a-2210c are configured to transmit or receive via wireless or wired communication channels. Each ED 2210a-2210c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 2220a-2220b here include base stations 2270a-2270b, respectively. Each base station 2270a-2270b is configured to wirelessly interface with one or more of the EDs 2210a-2210c to enable access to the core network 2230, the PSTN 2240, the Internet 2250, or the other networks 2260. For example, the base stations 2270a-2270b may include (or be) one or more of several well-known devices, such as a base transceiver station (BTS), a Node-B (NodeB), an evolved NodeB (eNodeB), a Next Generation (NG) NodeB (gNB), a Home NodeB, a Home eNodeB, a site controller, an access point (AP), or a wireless router. The EDs 2210a-2210c are configured to interface and communicate with the Internet 2250 and may access the core network 2230, the PSTN 2240, or the other networks 2260.

In the embodiment shown in FIG. 22, the base station 2270a forms part of the RAN 2220a, which may include other base stations, elements, or devices. Also, the base station 2270b forms part of the RAN 2220b, which may include other base stations, elements, or devices. Each base station 2270a-2270b operates to transmit or receive wireless signals within a particular geographic region or area, sometimes referred to as a “cell.” In some embodiments, multiple-input multiple-output (MIMO) technology may be employed having multiple transceivers for each cell.

The base stations 2270a-2270b communicate with one or more of the EDs 2210a-2210c over one or more air interfaces 2290 using wireless communication links. The air interfaces 2290 may utilize any suitable radio access technology.

It is contemplated that the system 2200 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 2220a-2220b are in communication with the core network 2230 to provide the EDs 2210a-2210c with voice, data, application, Voice over Internet Protocol (VoIP), or other services. Understandably, the RANs 2220a-2220b or the core network 2230 maybe in direct or indirect communication with one or more other RANs (not shown). The core network 2230 may also serve as a gateway access for other networks (such as the PSTN 2240, the Internet 2250, and the other networks 2260). In addition, some or all of the EDs 2210a-2210c may include functionality for communicating with different wireless networks over different wireless links using different wireless technologies or protocols. Instead of wireless communication (or in addition thereto), the EDs may communicate via wired communication channels to a service provider or switch (not shown), and to the Internet 2250.

Although FIG. 22 illustrates one example of a communication system, various changes maybe made to FIG. 22. For example, the communication system 2200 could include any number of EDs, base stations, networks, or other components in any suitable configuration.

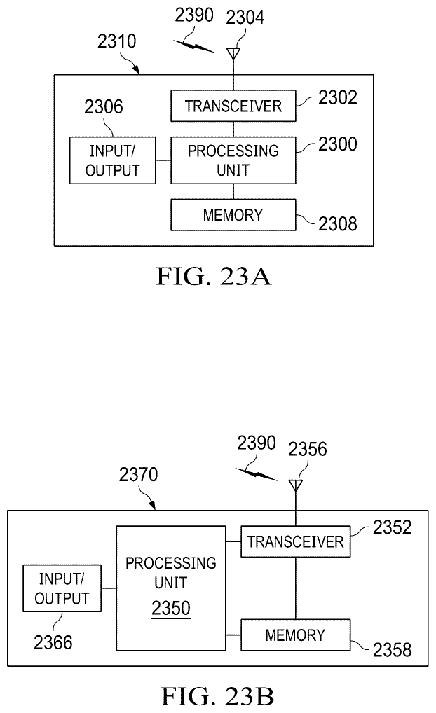

FIGS. 23A and 23B illustrate example devices that may implement the methods and teachings according to this disclosure. In particular, FIG. 23A illustrates an example ED 2310, and FIG. 23B illustrates an example base station 2370. These components could be used in the system 2200 or in any other suitable system.

As shown in FIG. 23A, the ED 2310 includes at least one processing unit 2300. The processing unit 2300 implements various processing operations of the ED 2310. For example, the processing unit 2300 could perform signal coding, data processing, power control, input/output processing, or any other functionality enabling the ED 2310 to operate in the system 1000. The processing unit 2300 also supports the methods and teachings described in more detail above. Each processing unit 2300 includes any suitable processing or computing device configured to perform one or more operations. Each processing unit 2300 could, for example, include a microprocessor, microcontroller, digital signal processor, field programmable gate array, or application specific integrated circuit.

The ED 2310 also includes at least one transceiver 2302. The transceiver 2302 is configured to modulate data or other content for transmission by at least one antenna or NIC (Network Interface Controller) 2304. The transceiver 2302 is also configured to demodulate data or other content received by the at least one antenna 2304. Each transceiver 2302 includes any suitable structure for generating signals for wireless or wired transmission or processing signals received wirelessly or by wire. Each antenna 2304 includes any suitable structure for transmitting or receiving wireless or wired signals 2390. One or multiple transceivers 2302 could be used in the ED 2310, and one or multiple antennas 2304 could be used in the ED 2310. Although shown as a single functional unit, a transceiver 2302 could also be implemented using at least one transmitter and at least one separate receiver.

The ED 2310 further includes one or more input/output devices 2306 or interfaces (such as a wired interface to the Internet 2250). The input/output devices 2306 facilitate interaction with a user or other devices (network communications) in the network. Each input/output device 2306 includes any suitable structure for providing information to or receiving information from a user, such as a speaker, microphone, keypad, keyboard, display, or touch screen, including network interface communications.

In addition, the ED 2310 includes at least one memory 2308. The memory 2308 stores instructions and data used, generated, or collected by the ED 2310. For example, the memory 2308 could store software or firmware instructions executed by the processing unit(s) 2300 and data used to reduce or eliminate interference in incoming signals. Each memory 2308 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 23B, the base station 2370 includes at least one processing unit 2350, at least one transceiver 2352, which includes functionality for a transmitter and a receiver, one or more antennas 2356, at least one memory 2358, and one or more input/output devices or interfaces 2366. A scheduler, which would be understood by one skilled in the art, is coupled to the processing unit 2350. The scheduler could be included within or operated separately from the base station 2370. The processing unit 2350 implements various processing operations of the base station 2370, such as signal coding, data processing, power control, input/output processing, or any other functionality. The processing unit 2350 can also support the methods and teachings described in more detail above. Each processing unit 2350 includes any suitable processing or computing device configured to perform one or more operations. Each processing unit 2350 could, for example, include a microprocessor, microcontroller, digital signal processor, field programmable gate array, or application specific integrated circuit.

Each transceiver 2352 includes any suitable structure for generating signals for wireless or wired transmission to one or more EDs or other devices. Each transceiver 2352 further includes any suitable structure for processing signals received wirelessly or by wire from one or more EDs or other devices. Although shown combined as a transceiver 2352, a transmitter and a receiver could be separate components. Each antenna 2356 includes any suitable structure for transmitting or receiving wireless or wired signals 2390. While a common antenna 2356 is shown here as being coupled to the transceiver 2352, one or more antennas 2356 could be coupled to the transceiver(s) 2352, allowing separate antennas 2356 to be coupled to the transmitter and the receiver if equipped as separate components. Each memory 2358 includes any suitable volatile or non-volatile storage and retrieval device(s). Each input/output device 2366 facilitates interaction with a user or other devices (network communications) in the network. Each input/output device 2366 includes any suitable structure for providing information to or receiving/providing information from a user, including network interface communications.

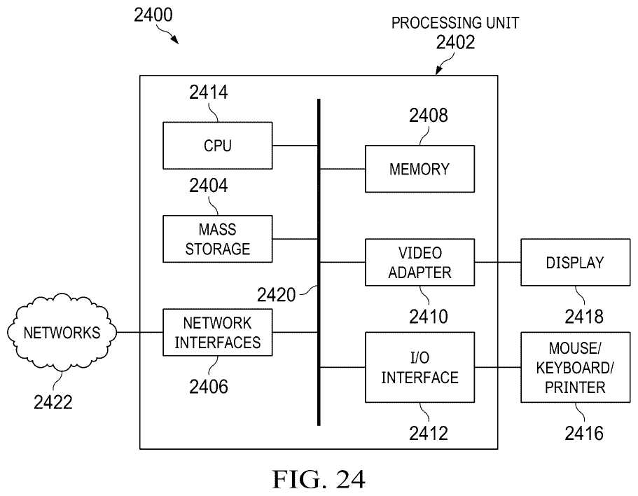

FIG. 24 is a block diagram of a computing system 2400 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 2400 includes a processing unit 2402. The processing unit includes a central processing unit (CPU) 2414, memory 2408, and may further include a mass storage device 2404, a video adapter 2410, and an I/O interface 2412 connected to a bus 2420.

The bus 2420 may be one or more of any type of several bus architectures including a memory bus or memory controller, a peripheral bus, or a video bus. The CPU 2414 may comprise any type of electronic data processor. The memory 2408 may comprise any type of non-transitory system memory such as static random access memory (SRAM), dynamic random access memory (DRAM), synchronous DRAM (SDRAM), read-only memory (ROM), or a combination thereof. In an embodiment, the memory 2408 may include ROM for use at boot-up, and DRAM for program and data storage for use while executing programs.

The mass storage 2404 may comprise any type of non-transitory storage device configured to store data, programs, and other information and to make the data, programs, and other information accessible via the bus 2420. The mass storage 2404 may comprise, for example, one or more of a solid state drive, hard disk drive, a magnetic disk drive, or an optical disk drive.

The video adapter 2410 and the I/O interface 2412 provide interfaces to couple external input and output devices to the processing unit 2402. As illustrated, examples of input and output devices include a display 2418 coupled to the video adapter 2410 and a mouse, keyboard, or printer 2416 coupled to the I/O interface 2412. Other devices may be coupled to the processing unit 2402, and additional or fewer interface cards may be utilized. For example, a serial interface such as Universal Serial Bus (USB) (not shown) may be used to provide an interface for an external device.

The processing unit 2402 also includes one or more network interfaces 2406, which may comprise wired links, such as an Ethernet cable, or wireless links to access nodes or different networks. The network interfaces 2406 allow the processing unit 2402 to communicate with remote units via the networks. For example, the network interfaces 2406 may provide wireless communication via one or more transmitters/transmit antennas and one or more receivers/receive antennas. In an embodiment, the processing unit 2402 is coupled to a local-area network 2422 or a wide-area network for data processing and communications with remote devices, such as other processing units, the Internet, or remote storage facilities.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a performing unit or module, a generating unit or module, an obtaining unit or module, a shifting unit or module, a puncturing unit or module, a determining unit or module, a modifying unit or module, a reducing unit or module, a removing unit or module, or a selecting unit or module. The respective units or modules maybe hardware, software, or a combination thereof. For instance, one or more of the units or modules maybe an integrated circuit, such as field programmable gate arrays (FPGAs) or application-specific integrated circuits (ASICs).

The following references are related to the subject matter of the present application. Each of these references is incorporated herein by reference in its entirety:
3GPP TS 38.104, “NR; Base Station (BS) radio transmission and reception,” V17.4.0 (2021-12).
3GPP TS 38.213, “NR; Physical layer procedures for control,” V17.0.0 (2021-12).
3GPP TS 38.211, “NR; Physical channels and modulation,” V17.0.0 (2021-12).
TR 38.817-01, “General aspects for User Equipment (UE) Radio Frequency (RF) for NR,” V16.3.0 (2021-09).
RP-213603, “NR support for dedicated spectrum less than 5 MHz for FR1”, RAN #94, Nokia, Dec. 6-17, 2021.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed is:

1. A method comprising:
receiving, by a user equipment (UE) from a base station, a punctured synchronization signal block (SSB) in a channel of a frequency band, wherein:
the punctured SSB comprises a primary synchronization signal (PSS), a secondary synchronization signal (SSS), and a punctured physical broadcast channel (PBCH) obtained from a first PBCH of a first SSB based on a puncture pattern to reduce a first number of resource blocks (RBs) of the first PBCH to a second number of RBs for transmission, and
the PSS of the punctured SSB has a center frequency indicated by a first sync raster location from a first set of sync raster locations associated with the punctured SSB; and
detecting, by the UE, the punctured SSB according to the first sync raster location.

2. The method of claim 1, wherein a third bandwidth of the punctured SSB is related to the second number of RBs and is not larger than a second bandwidth of the channel, and a first bandwidth of the first SSB exceeds the second bandwidth of the channel.

3. The method of claim 1, further comprising:
determining, by the UE, attributes of the channel based on the punctured PBCH in the punctured SSB, the attributes comprising a starting frequency location of the channel, wherein determining the attributes of the channel comprises:
determining, by the UE, the starting frequency location of the channel based on the punctured PBCH, a frequency location of an RB occupied by the PSS of the punctured SSB, and an offset with respect to the frequency location of the RB.

4. The method of claim 1, wherein the PSS of the first SSB has a center frequency indicated by a second sync raster location of a second set of sync raster locations.

5. The method of claim 4, wherein frequencies of the first set of sync raster locations are based on a first raster spacing, frequencies of the second set of sync raster locations are based on a second raster spacing, the second raster spacing is a multiple of the first raster spacing, and the first set of sync raster locations is obtained by shifting the second set of sync raster locations in a frequency domain.

6. The method of claim 1, wherein a second bandwidth of the channel is less than 5 MHz.

7. A method comprising:
generating, by a base station, a punctured synchronization signal block (SSB) for a channel of a frequency band based on a first bandwidth of a first SSB exceeding a second bandwidth of the channel, wherein
the first SSB comprises a first physical broadcast channel (PBCH), a primary synchronization signal (PSS), and a secondary synchronization signal (SSS),
the punctured SSB comprises the PSS and the SSS, and a punctured PBCH obtained from the first PBCH by applying a puncture pattern to reduce a first number of resource blocks (RBs) of the first PBCH to a second number of RBs for transmission, and
the PSS of the punctured SSB has a center frequency indicated by a first sync raster location from a first set of sync raster locations associated with the punctured SSB; and
transmitting, by the base station, the punctured SSB in the channel.

8. The method of claim 7, wherein a third bandwidth of the punctured SSB is related to the second number of RBs and is not larger than the second bandwidth of the channel.

9. The method of claim 7, wherein the punctured PBCH comprises information indicating attributes of the channel, the attributes comprising a starting frequency location of the channel, and wherein the starting frequency location of the channel is determinable based on the punctured PBCH, a frequency location of an RB occupied by the PSS of the punctured SSB, and an offset with respect to the frequency location of the RB.

10. The method of claim 7, wherein the PSS of the first SSB has a center frequency indicated by a second sync raster location of a second set of sync raster locations.

11. The method of claim 10, wherein frequencies of the first set of sync raster locations are based on a first raster spacing, and frequencies of the second set of sync raster locations are based on a second raster spacing, the second raster spacing is a multiple of the first raster spacing, and the first set of sync raster locations is obtained by shifting the second set of sync raster locations in a frequency domain.

12. The method of claim 7, wherein the second bandwidth of the channel is less than 5 MHz.

13. A user equipment (UE) comprising:
a non-transitory memory storage comprising instructions; and
one or more processors in communication with the non-transitory memory storage, wherein the instructions, when executed by the one or more processors, cause the UE to perform operations including:
receiving, from a base station, a punctured synchronization signal block (SSB) in a channel of a frequency band, wherein:
the punctured SSB comprises a primary synchronization signal (PSS), a secondary synchronization signal (SSS), and a punctured physical broadcast channel (PBCH) obtained from a first PBCH of a first SSB based on a puncture pattern to reduce a first number of resource blocks (RBs) of the first PBCH to a second number of RBs for transmission, and
the PSS of the punctured SSB has a center frequency indicated by a first sync raster location from a first set of sync raster locations associated with the punctured SSB; and
detecting the punctured SSB according to the first sync raster location.

14. The UE of claim 13, wherein a third bandwidth of the punctured SSB is related to the second number of RBs and is not larger than a second bandwidth of the channel, and a first bandwidth of the first SSB exceeds the second bandwidth of the channel.

15. The UE of claim 13, the operations further comprising:
determining, by the UE, attributes of the channel based on the punctured PBCH in the punctured SSB, the attributes comprising a starting frequency location of the channel, wherein determining the attributes of the channel comprises:
determining, by the UE, the starting frequency location of the channel based on the punctured PBCH, a frequency location of an RB occupied by the PSS of the punctured SSB, and an offset with respect to the frequency location of the RB.

16. The UE of claim 13, wherein the PSS of the first SSB has a center frequency indicated by a second sync raster location of a second set of sync raster locations.

17. The UE of claim 16, wherein frequencies of the first set of sync raster locations are based on a first raster spacing, frequencies of the second set of sync raster locations are based on a second raster spacing, the second raster spacing is a multiple of the first raster spacing, and the first set of sync raster locations is obtained by shifting the second set of sync raster locations in a frequency domain.

18. The UE of claim 13, wherein a second bandwidth of the channel is less than 5 MHz.

19. A base station comprising:
a non-transitory memory storage comprising instructions; and
one or more processors in communication with the non-transitory memory storage, wherein the instructions, when executed by the one or more processors, cause the base station to perform operations including:
generating a punctured synchronization signal block (SSB) for a channel of a frequency band based on a first bandwidth of a first SSB exceeding a second bandwidth of the channel, wherein:
the first SSB comprises a first physical broadcast channel (PBCH), a primary synchronization signal (PSS), and a secondary synchronization signal (SSS),
the punctured SSB comprises the PSS and the SSS, and a punctured PBCH obtained from the first PBCH by applying a puncture pattern to reduce a first number of resource blocks (RBs) of the first PBCH to a second number of RBs for transmission, and
the PSS of the punctured SSB has a center frequency indicated by a first sync raster location from a first set of sync raster locations associated with the punctured SSB; and
transmitting the punctured SSB in the channel.

20. The base station of claim 19, wherein a third bandwidth of the punctured SSB is related to the second number of RBs and is not larger than the second bandwidth of the channel.

21. The base station of claim 19, wherein the punctured PBCH comprises information indicating attributes of the channel, the attributes comprising a starting frequency location of the channel, and wherein the starting frequency location of the channel is determinable based on the punctured PBCH, a frequency location of an RB occupied by the PSS of the punctured SSB, and an offset with respect to the frequency location of the RB.

22. The base station of claim 19, wherein the PSS of the first SSB has a center frequency indicated by a second sync raster location of a second set of sync raster locations.

23. The base station of claim 22, wherein frequencies of the first set of sync raster locations are based on a first raster spacing, and frequencies of the second set of sync raster locations are based on a second raster spacing, the second raster spacing is a multiple of the first raster spacing, and the first set of sync raster locations is obtained by shifting the second set of sync raster locations in a frequency domain.

24. The base station of claim 19, wherein the second bandwidth of the channel is less than 5 MHz.
